(19) United States
(12) Patent Application Publication
(10) Pub. No.: US 2024/0384782 A1
(43) Pub. Date: Nov. 21, 2024

(54) ENGINE MANAGEMENT MODULE WITH ROTATIONAL INPUT

(71) Applicant: Skyryse, Inc., El Segundo, CA (US)

(72) Inventors: Paul Kapaun, Oxnard, CA (US); Andre A. Kashierski, Riverside, CA (US)

(21) Appl. No.: 18/666,618

(22) Filed: May 16, 2024

Related U.S. Application Data
(60) Provisional application No. 63/467,147, filed on May 17, 2023.
(60) Provisional application No. 63/526,507, filed on Jul. 13, 2023.

(51) Int. Cl. F16H 37/12; B64C 27/00; B64D 31/04

(52) U.S. Cl. CPC F16H 37/124; B64D 31/04; B64C 27/00

(57) ABSTRACT

Some embodiments relate to a device (e.g., an engine management module) that includes a drum coupled to a base, the drum configured to rotate about a drum rotation axis. The drum includes a channel along an outer surface of the drum. The device includes a lever coupled to a shaft that is fixed to the base. The lever has a first end and a second end, where the first end includes a guide pin that is positioned within the channel such that as the drum rotates about the drum rotation axis, the guide pin moves along the channel to cause the lever to translate along the shaft.

### CROSS-REFERENCE TO RELATED APPLICATIONS

This application claims the benefit of, and priority to, U.S. Provisional Patent Application Ser. No. 63/467,147, “Engine Management Module,” filed May 17, 2023, and U.S. Provisional Patent Application Ser. No. 63/526,507, “Engine Management Module,” filed Jul. 13, 2023, each of which is incorporated herein by reference in its entirety.

### TECHNICAL FIELD

The present disclosure generally relates to devices that convert linear or rotational inputs into a plurality of rotational and/or linear outputs.

### BACKGROUND

Vehicle engines often includes some form of digital engine control. For example, modern aircraft often include computer managed engine control systems (e.g., full authority digital engine control (FADEC)). FADECs generally control all aspects of engine performance in place of analog controls, and are generally integrated into modern aircrafts (e.g., designed to operate fly-by-wire). However, many vehicles in operation today do not include digital engine control, and instead are controlled using various analog inputs (e.g., pulling a knob to pull a cable that controls throttle). But it can be difficult to retrofit these types of vehicles to have digital control due inherent differences between digital and analog control. This is especially true for applications having strict safety, reliability, and weight restrictions (e.g., aviation).

### BRIEF DESCRIPTION OF THE DRAWINGS

The disclosed embodiments have other advantages and features which will be more readily apparent from the detailed description, the appended claims, and the accompanying figures (or drawings). A brief introduction of the figures is below.

Figure (FIG. 1 illustrates one example embodiment of a vehicle control and interface system, according to one or more embodiments.

FIG. 2 illustrates one example embodiment of a configuration for a set of universal vehicle control interfaces in a vehicle, according to one or more embodiments.

FIG. 3 is a perspective diagram of an example engine management module (EMM) that converts a single linear input into three rotational outputs.

FIG. 4 is a diagram of example channel paths for three guide plates of an example EMM (e.g., the EMM of FIG. 3).

FIGS. 5A-5C are diagrams of a second example EMM that converts a single linear input into three curvilinear outputs.

FIGS. 6A-6I are diagrams of a third example EMM that converts a single linear input into three curvilinear outputs.

FIG. 7 is a perspective diagram of an example EMM that converts a single rotational input into three linear outputs.

FIG. 8 is a diagram of example channel paths on a drum of an example EMM (e.g., the EMM of FIG. 7).

FIGS. 9-11 are example user interfaces that may (a) be displayed to an operator of a rotorcraft with an EMM and (b) enable the operator to control the EMM.

FIG. 12 is a block diagram illustrating components of an example machine able to read instructions from a machine-readable medium and execute them in a processor (or controller), according to one or more embodiments.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

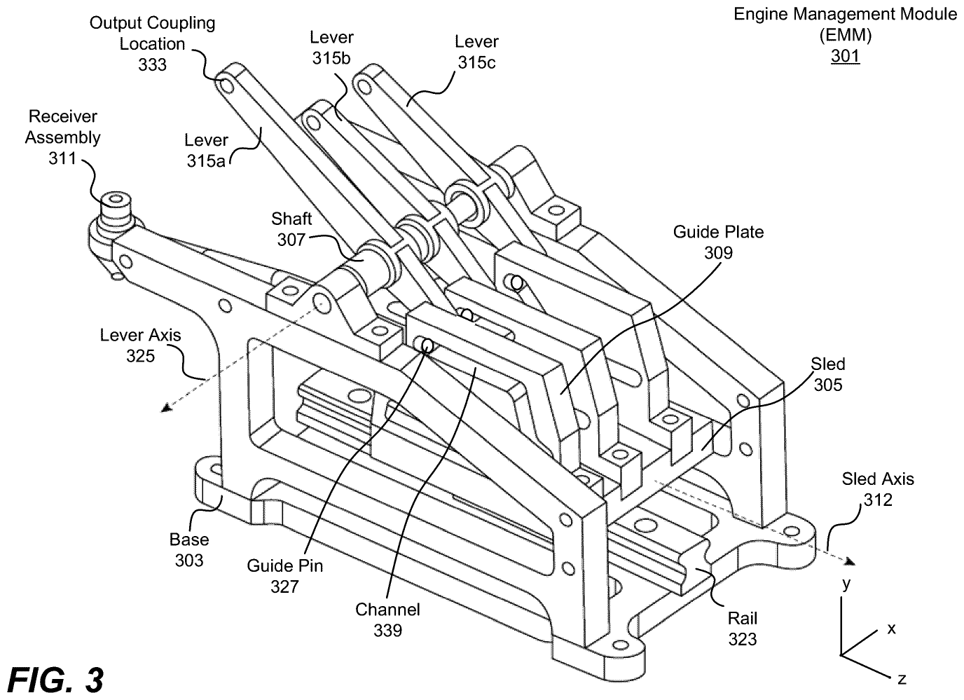

Described herein are engine management modules (EMMs). An EMM is a device (or apparatus or system) that converts (a) one or more linear inputs, one or more rotational inputs, one or more curvilinear inputs, or some combination thereof into (b) one or more linear outputs, one or more rotational outputs, one or more curvilinear inputs, or some combination thereof. The output of an EMM may be used to control an external system, such as an engine. For example, the mechanical output of an EMM interfaces with engine control cables (e.g., for fuel cut-off, throttle, and Power Turbine Governor (PTG) RPM). In some embodiments, an EMM may be used to control an engine in a rotorcraft that does not have a FADEC (Full Authority Digital Engine Control). EMMs are further described with respect to FIGS. 3-8.

### Example System Environment

Figure (FIG. 1 illustrates one example embodiment of a vehicle control and interface system 100. In the example embodiment shown, vehicle control and interface system 100 includes one or more universal vehicle control interfaces 110, universal vehicle control router 120, one or more vehicle actuators 130, one or more vehicle sensors 140, and one or more data stores 150. In other embodiments, the vehicle control and interface system 100 may include different or additional elements. Furthermore, the functionality may be distributed among the elements in a different manner than described. The elements of FIG. 1 may include one or more computers that communicate via a network or other suitable communication method.

The vehicle control and interface system 100 may be integrated with various vehicles having different mechanical, hardware, or software components. For example, the vehicle control and interface system 100 may be integrated with fixed-wing aircraft (e.g., airplanes), rotorcraft (e.g., helicopters), motor vehicles (e.g., automobiles), watercraft (e.g., power boats or submarines), or any other suitable vehicle. The vehicle control and interface system 100 is advantageously configured to receive inputs for requested operation of a particular vehicle via universal set of interfaces and the inputs to appropriate instructions for mechanical, hardware, or software components of the particular vehicle to achieve the requested operation. In doing so, the vehicle control and interface system 100 enables human operators to operate different vehicles using the same universal set of interfaces or inputs. By way of example, “universal” indicates that a feature of the vehicle control and interface system 100 may operate or be architected in a vehicle-agnostic manner. This allows for vehicle integration without necessarily having to design and configure vehicle specific customizations or reconfigurations in order to integrate the specific feature. Although universal features of the vehicle control and interface system 100 can function in a vehicle-agnostic manner, the universal features may still be configured for particular contexts. For example, the vehicle control or interface system 100 may receive or process inputs describing three-dimensional movements for vehicles that can move in three dimensions (e.g., aircraft) and conversely may receive or process inputs describing two-dimensional movements for vehicles that can move in two dimensions (e.g., automobiles). One skilled in the art will appreciate that other context-dependent configurations of universal features of the vehicle control and interface system 100 are possible.

The universal vehicle control interfaces 110 is a set of universal interfaces configured to receive a set of universal vehicle control inputs to the vehicle control and interface system 100. The universal vehicle control interfaces 110 may include one or more digital user interfaces presented to an operator of a vehicle via one or more electronic displays. Additionally, or alternatively, the universal vehicle control interfaces 110 may include one or more hardware input devices, e.g., one or more control sticks inceptors, such as side sticks, center sticks, throttles, cyclic controllers, or collective controllers. The universal vehicle control interfaces 110 receive universal vehicle control inputs requesting operation of a vehicle. In particular, the inputs received by the universal vehicle control interfaces 110 may describe a requested trajectory of the vehicle, such as to change a velocity of the vehicle in one or more dimensions or to change an orientation of the vehicle. Because the universal vehicle control inputs describe an intended trajectory of a vehicle directly rather than describing vehicle-specific precursor values for achieving the intended trajectory, such as vehicle attitude inputs (e.g., power, lift, pitch, roll yaw), the universal vehicle control inputs can be used to universally describe a trajectory of any vehicle. This is in contrast to existing systems where control inputs are received as vehicle-specific trajectory precursor values that are specific to the particular vehicle. Advantageously, any individual interface of the set of universal vehicle control interfaces 110 configured to received universal vehicle control inputs can be used to completely control a trajectory of a vehicle. This is in contrast to conventional systems, where vehicle trajectory must be controlled using two or more interfaces or inceptors that correspond to different axes of movement or vehicle actuators. For instance, conventional rotorcraft systems include different cyclic (controlling pitch and roll), collective (controlling heave), and pedal (controlling yaw) inceptors. Similarly, conventional fixed-wing aircraft systems include different stick or yoke (controlling pitch and role), power (controlling forward movement), and pedal (controlling yaw) inceptors.

In various embodiments, inputs received by the universal vehicle control interfaces 110 can include “steady-hold” inputs, which may be configured to hold a parameter value fixed (e.g., remain in a departed position) without a continuous operator input. Such variants can enable hands-free operation, where discontinuous or discrete inputs can result in a fixed or continuous input. In a specific example, a user of the universal vehicle control interfaces 110 can provide an input (e.g., a speed input) and subsequently remove their hands with the input remaining fixed. Alternatively, or additionally, inputs received by the universal vehicle control interfaces 110 can include one or more self-centering or automatic return inputs, which return to a default state without a continuous user input.

In some embodiments, the universal vehicle control interfaces 110 include interfaces that provide feedback information to an operator of the vehicle. For instance, the universal vehicle control interfaces 110 may provide information describing a state of a vehicle integrated with the universal vehicle control interfaces 110 (e.g., current vehicle speed, direction, orientation, location, etc.). Additionally, or alternatively, the universal vehicle control interfaces 110 may provide information to facilitate navigation or other operations of a vehicle, such as visualizations of maps, terrain, or other environmental features around the vehicle.

The universal vehicle control router 120 routes universal vehicle control inputs describing operation of a vehicle to components of the vehicle suitable for executing the operation. In particular, the universal vehicle control router 120 receives universal vehicle control inputs describing the operation of the vehicle, processes the inputs using information describing characteristics of the aircraft, and outputs a corresponding set of commands for actuators of the vehicle (e.g., the vehicle actuators 130) suitable to achieve the operation. The universal vehicle control router 120 may use various information describing characteristics of a vehicle in order to convert universal vehicle control inputs to a suitable set of commands for actuators of the vehicle. Additionally, or alternatively, the universal vehicle control router 120 may convert universal vehicle control inputs to a set of actuator commands using a set of control laws that enforce constraints (e.g., limits) on operations requested by the universal control inputs. For example, the set of control laws may include velocity limits (e.g., to prevent stalling in fixed-wing aircraft), acceleration limits, turning rate limits, engine power limits, rotor revolution per minute (RPM) limits, load power limits, allowable descent altitude limits, etc. After determining a set of actuator commands, the universal vehicle control router 120 may transmit the commands to relevant components of the vehicle for causing corresponding actuators to execute the commands. The universal vehicle control router 120 may transmit actuator commands to one or more actuators 130 coupled to an engine management module (EMM) that controls multiple vehicle control components (e.g., inputs to a system, such as engine). EMMs are further described with respect to FIGS. 3-8.

The universal vehicle control router 120 can decouple axes of movement for a vehicle in order to process received universal vehicle control inputs. In particular, the universal vehicle control router 120 can process a received universal vehicle control input for one axis of movement without impacting other axes of movement such that the other axes of movement remain constant. In this way, the universal vehicle control router 120 can facilitate “steady-hold” vehicle control inputs, as described above with reference to the universal vehicle control interfaces 110. This is in contrast to conventional systems, where a vehicle operator must manually coordinate all axes of movement independently for a vehicle in order to produce movement in one axis (e.g., a pure turn, a pure altitude climb, a pure forward acceleration, etc.) without affecting the other axes of movement.

In some embodiments, the universal vehicle control router 120 is configured to use one or more models corresponding to a particular vehicle to convert universal vehicle control inputs to a suitable set of commands for actuators of the vehicle. For example, a model may include a set of parameters (e.g., numerical values) that can be used as input to universal input conversion processes in order to generate actuator commands suitable for a particular vehicle. In this way, the universal vehicle control router 120 can be integrated with vehicles by substituting models used by processes of the universal vehicle control router 120, enabling efficient integration of the vehicle control and interface system 100 with different vehicles. The one or more models may be obtained by the universal vehicle control router 120 from a vehicle model database or other first-party or third-party system, e.g., via a network. In some cases, the one or more models may be static after integration with the vehicle control and interface system 100, such as if a vehicle integrated with the vehicle control and interface system 100 receives is certified for operation by a certifying authority (e.g., the United States Federal Aviation Administration). In some embodiments, parameters of the one or more models are determined by measuring data during real or simulated operation of a corresponding vehicle and fitting the measured data to the one or more models.

In some embodiments, the universal vehicle control router 120 processes universal vehicle control inputs according to a current phase of operation of the vehicle. For instance, if the vehicle is a rotorcraft, the universal vehicle control router 120 may convert a universal input describing an increase in lateral speed to one or more actuator commands differently if the rotorcraft is in a hover phase or in a forward flight phase. In particular, in processing the lateral speed increase universal input the universal vehicle control router 120 may generate actuator commands causing the rotorcraft to strafe if the rotorcraft is hovering and causing the rotorcraft to turn if the rotorcraft is in forward flight. As another example, in processing a turn speed increase universal input the universal vehicle control router 120 may generate actuator commands causing the rotorcraft to perform a pedal turn if the rotorcraft is hovering and ignore the turn speed increase universal input if the rotorcraft is in another phase of operation. As a similar example for a fixed-wing aircraft, in processing a turn speed increase universal input the universal vehicle control router 120 may generate actuator commands causing the fixed-wing aircraft to perform tight ground turn if the fixed-wing aircraft is grounded and ignore the turn speed increase universal input if the fixed-wing aircraft is in another phase of operation. One skilled in the art will appreciate that the universal vehicle control router 120 may perform other suitable processing of universal vehicle control inputs to generate actuator commands in consideration of vehicle operation phases for various vehicles.

The vehicle actuators 130 are one or more actuators configured to control components of a vehicle (e.g., integrated with the universal vehicle control interfaces 110). For instance, the vehicle actuators may include actuators for controlling a power-plant of the vehicle (e.g., an engine). Furthermore, the vehicle actuators 130 may vary depending on the particular vehicle. For example, if the vehicle is a rotorcraft the vehicle actuators 130 may include actuators for controlling lateral cyclic, longitudinal cyclic, collective, and pedal controllers of the rotorcraft. As another example, if the vehicle is a fixed-wing aircraft the vehicle actuators 130 may include actuators for controlling a rudder, elevator, ailerons, and power-plant of the fixed-wing aircraft. One or more actuators 130 may be coupled to an engine management module (EMM) that controls multiple control components (e.g., inputs to a system, such as engine). EMMs are further described with respect to FIGS. 3-8.

The vehicle sensors 140 are sensors configured to capture corresponding sensor data. In various embodiments the vehicle sensors 140 may include, for example, one or more global positioning system (GPS) receivers, inertial measurement units (IMUs), accelerometers, gyroscopes, magnometers, pressure sensors (altimeters, static tubes, pitot tubes, etc.), temperature sensors, vane sensors, range sensors (e.g., laser altimeters, radar altimeters, lidars, radars, ultrasonic range sensors, etc.), terrain elevation data, geographic data, airport or landing zone data, rotor revolutions per minute (RPM) sensors, manifold pressure sensors, or other suitable sensors. In some cases, the vehicle sensors 140 may include, for example, redundant sensor channels for some or all of the vehicle sensors 140. The vehicle control and interface system 100 may use data captured by the vehicle sensors 140 for various processes. By way of example, the universal vehicle control router 120 may use vehicle sensor data captured by the vehicle sensors 140 to determine an estimated state of the vehicle.

The data store 150 is a database storing various data for the vehicle control and interface system 100. For instance, the data store 150 may store sensor data (e.g., captured by the vehicle sensors 140), vehicle models, vehicle metadata, or any other suitable data.

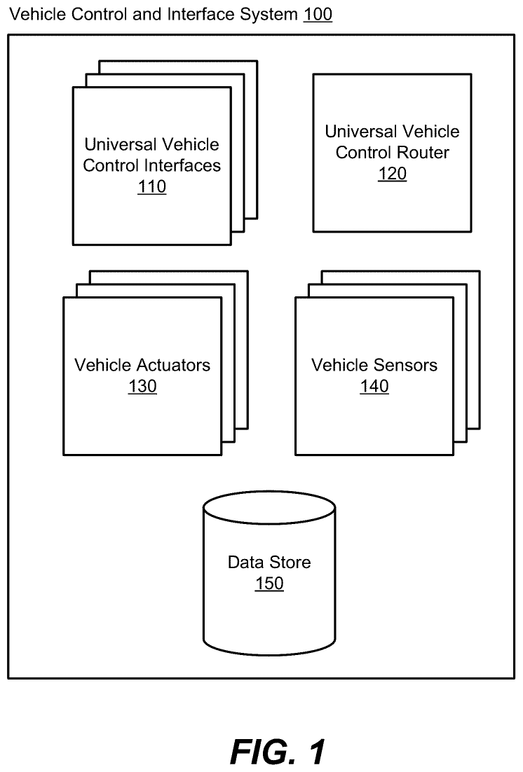

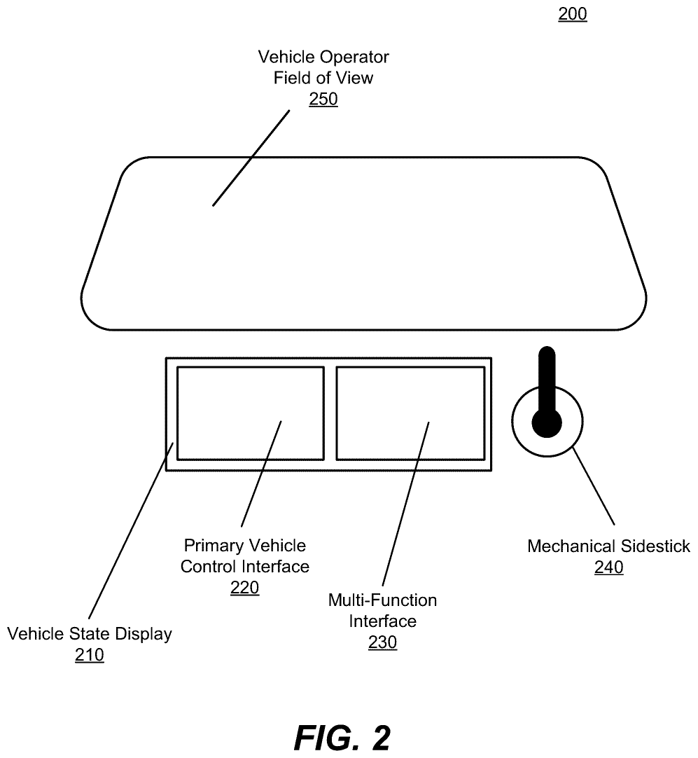

FIG. 2 illustrates one example embodiment of a configuration 200 for a set of universal vehicle control interfaces in a vehicle. The vehicle control interfaces in the configuration 200 may be embodiments of the universal vehicle control interfaces 110, as described above with reference to FIG. 1. In the embodiment shown, the configuration 200 includes a vehicle state display 210, a side-stick inceptor device 240, and a vehicle operator field of view 250. In other embodiments, the configuration 200 may include different or additional elements. Furthermore, the functionality may be distributed among the elements in a different manner than described.

The vehicle state display 210 is one or more electronic displays (e.g., liquid-crystal displays (LCDs) configured to display or receive information describing a state of the vehicle including the configuration 200. In particular, the vehicle state display 210 may display various interfaces including feedback information for an operator of the vehicle. In this case, the vehicle state display 210 may provide feedback information to the operator in the form of virtual maps, 3D terrain visualizations (e.g., wireframe, rendering, environment skin, etc.), traffic, weather, engine status, communication data (e.g., air traffic control (ATC) communication), guidance information (e.g., guidance parameters, trajectory), and any other pertinent information. Additionally, or alternatively, the vehicle state display 210 may display various interfaces for configuring or executing automated vehicle control processes, such as automated aircraft landing or takeoff or navigation to a target location. The vehicle state display 210 may receive user inputs via various mechanisms, such as gesture inputs (as described above with reference to the gesture interface 220), audio inputs, or any other suitable input mechanism.

As depicted in FIG. 2 the vehicle state display 210 includes a primary vehicle control interface 220 and a multi-function interface 230. The primary vehicle control interface 220 is configured to facilitate short-term of the vehicle including the configuration 200. In particular, the primary vehicle control interface 220 includes information immediately relevant to control of the vehicle, such as current universal control input values or a current state of the vehicle. As an example, the primary vehicle control interface 220 may include a virtual object representing the vehicle in 3D or 2D space. In this case, the primary vehicle control interface 220 may adjust the display of the virtual object responsive to operations performed by the vehicle in order to provide an operator of the vehicle with visual feedback. The primary vehicle control interface 220 may additionally, or alternatively, receive universal vehicle control inputs via gesture inputs.

The multi-function interface 230 is configured to facilitate long-term control of the vehicle including the configuration 200. In particular, the primary vehicle control interface 220 may include information describing a mission for the vehicle (e.g., navigation to a target destination) or information describing the vehicle systems. Information describing the mission may include routing information, mapping information, or other suitable information. Information describing the vehicle systems may include engine health status, engine power utilization, fuel, lights, vehicle environment, or other suitable information. In some embodiments, the multi-function interface 230 or other interfaces enable mission planning for operation of a vehicle. For example, the multi-function interface 230 may enable configuring missions for navigating a vehicle from a start location to a target location. In some cases, the multi-function interface 230 or another interface provides access to a marketplace of applications and services. The multi-function interface 230 may also include a map, a radio tuner, or a variety of other controls and system functions for the vehicle.

In some embodiments, the vehicle state display 210 includes information describing a current state of the vehicle relative to one or more control limits of the vehicle (e.g., on the primary vehicle control interface 220 or the multi-function interface 230). For example, the information may describe power limits of the vehicle or include information indicating how much control authority a use has across each axis of movement for the vehicle (e.g., available speed, turning ability, climb or descent ability for an aircraft, etc.). In the same or different example embodiments, the vehicle state display 210 may display different information depending on a level of experience of a human operator of the vehicle. For instance, if the vehicle is an aircraft and the human operator is new to flying, the vehicle state display may include information indicating a difficulty rating for available flight paths (e.g., beginner, intermediate, or expert). The particular experience level determined for an operator may be based upon prior data collected and analyzed about the human operator corresponding to their prior experiences in flying with flight paths having similar expected parameters. Additionally, or alternatively, flight path difficulty ratings for available flight paths provided to the human operator may be determined based on various information, for example, expected traffic, terrain fluctuations, airspace traffic and traffic type, how many airspaces and air traffic controllers along the way, or various other factors or variables that are projected for a particular flight path. Moreover, the data collected from execution of this flight path can be fed back into the database and applied to a machine learning model to generate additional and/or refined ratings data for the operator for subsequent application to other flight paths. Vehicle operations may further be filtered according to which one is the fastest, the most fuel efficient, or the most scenic, etc.

The one or more vehicle state displays 210 may include one or more electronic displays (e.g., liquid-crystal displays (LCDs), organic light emitting diodes (OLED), plasma). For example, the vehicle state display 210 may include a first electronic display for the primary vehicle control interface 220 and a second electronic display for the multi-function interface 230. In cases where the vehicle state display 210 include multiple electronic displays, the vehicle state display 210 may be configured to adjust interfaces displayed using the multiple electronic displays, e.g., in response to failure of one of the electronic displays. For example, if an electronic display rendering the primary vehicle control interface 220 fails, the vehicle state display 210 may display some or all of the primary vehicle control interface 220 on another electronic display.

The one or more electronic displays of the vehicle state display 210 may be touch sensitive displays is configured to receive touch inputs from an operator of the vehicle including the configuration 200, such as a multi-touch display. For instance, the primary vehicle control interface 220 may be a gesture interface configured to receive universal vehicle control inputs for controlling the vehicle including the configuration 200 via touch gesture inputs. In some cases, the one or more electronic displays may receive inputs via other type of gestures, such as gestures received via an optical mouse, roller wheel, three-dimensional (3D) mouse, motion tracking device (e.g., optical tracking), or any other suitable device for receiving gesture inputs.

Touch gesture inputs received by one or more electronic displays of the vehicle state display 210 may include single finger gestures (e.g., executing a predetermined pattern, swipe, slide, etc.), multi-finger gestures (e.g., 2, 3, 4, 5 fingers, but also palm, multi-hand, including/excluding thumb, etc.; same or different motion as single finger gestures), pattern gestures (e.g., circle, twist, convergence, divergence, multi-finger bifurcating swipe, etc.), or any other suitable gesture inputs. Gesture inputs can be limited asynchronous inputs (e.g., single input at a time) or can allow for multiple concurrent or synchronous inputs. In variants, gesture input axes can be fully decoupled or independent. In a specific example, requesting a speed change holds other universal vehicle control input parameters fixed—where vehicle control can be automatically adjusted in order to implement the speed change while holding heading and vertical rate fixed. Alternatively, gesture axes can include one or more mutual dependencies with other control axes. Unlike conventional vehicle control systems, such as aircraft control systems, the gesture input configuration as disclosed provides for more intuitive user experiences with respect to an interface to control vehicle movement.

In some embodiments, the vehicle state display 210 or other interfaces are configured to adjust in response to vehicle operation events, such as emergency conditions. For instance, in response to determining the vehicle is in an emergency condition, the vehicle control and interface system 100 may adjust the vehicle state display 210 to include essential information or remove irrelevant information. As an example, if the vehicle is an aircraft and the vehicle control and interface system 100 detects an engine failure for the aircraft, the vehicle control and interface system 100 may display essential information on the vehicle state display 210 including 1) a direction of the wind, 2) an available glide range for the aircraft (e.g., a distance that the aircraft can glide given current conditions), or 3) available emergency landing spots within the glide range. The vehicle control and interface system 100 may identify emergency landing locations using various processes, such as by accessing a database of landing spots (e.g., included in the data store 150 or a remote database) or ranking landing spots according to their suitability for an emergency landing.

The side-stick inceptor device 240 may be a side-stick inceptor configured to receive universal vehicle control inputs. In particular, the side-stick inceptor device 240 may be configured to receive the same or similar universal vehicle control inputs as a gesture interface of the vehicle state display 210 is configured to receive. In this case, the gesture interface and the side-stick inceptor device 240 may provide redundant or semi-redundant interfaces to a human operator for providing universal vehicle control inputs. The side-stick inceptor device 240 may be active or passive. Additionally, the side-stick inceptor device 240 and may include force feedback mechanisms along any suitable axis. For instance, the side-stick inceptor device 240 may be a 3-axis inceptor, 4-axis inceptor (e.g., with a thumb wheel), or any other suitable inceptor.

The components of the configuration 200 may be integrated with the vehicle including the configuration 200 using various mechanical or electrical components. These components may enable adjustment of one or more interfaces of the configuration 200 for operation by a human operator of the vehicle. For example, these components may enable rotation or translation of the vehicle state display 210 toward or away from a position of the human operator (e.g., a seat where the human operator sits). Such adjustment may be intended, for example, to prevent the interfaces of the configuration 200 from obscuring a line of sight of the human operator to the vehicle operator field of view 250.

The vehicle operator field of view 250 is a first-person field of view of the human operator of the vehicle including the configuration 200. For example, the vehicle operator field of view 250 may be a windshield of the vehicle or other suitable device for enabling a first-person view for a human operator.

The configuration 200 additionally or alternately include other auxiliary feedback mechanisms, which can be auditory (e.g., alarms, buzzers, etc.), haptic (e.g., shakers, haptic alert mechanisms, etc.), visual (e.g., lights, display cues, etc.), or any other suitable feedback components. Furthermore, displays of the configuration 200 (e.g., the vehicle state display 210) can simultaneously or asynchronously function as one or more of different types of interfaces, such as an interface for receiving vehicle control inputs, an interface for displaying navigation information, an interface for providing alerts or notifications to an operator of the vehicle, or any other suitable vehicle instrumentation. Furthermore, portions of the information can be shared between multiple displays or configurable between multiple displays.

### Example Engine Management Modules (EMMs)

Described herein are engine management modules (EMMs). An EMM is a device (or apparatus or system) that converts (a) one or more linear inputs, one or more rotational inputs, one or more curvilinear inputs, or some combination thereof into (b) one or more linear outputs, one or more rotational outputs, one or more curvilinear outputs, or some combination thereof. The output of an EMM may be used to control an external system. For convenience of description, the output of EMMs are generally described as controlling inputs to an engine. In a more specific example, the mechanical output of an EMM interfaces with engine control cables (e.g., for fuel cut-off, throttle, and Power Turbine Governor (PTG) RPM). An EMM may be used to control an engine of a vehicle (e.g., rotary aircraft, fixed wing aircraft, car, or boat), for example, that is not controlled by a computer managed engine control system. In some embodiments, an EMM may be used to control an engine in a rotorcraft that does not have a FADEC (Full Authority Digital Engine Control). However, outputs of EMMs are not limited to controlling inputs of an engine. The EMM may be used to control other external systems as well, such as landing gear systems, high-lift systems (e.g., flaps or slats), spoiler systems, and brake systems.

An EMM may generally be described as an “n-to-N EMM,” where n (a positive integer of 1 or greater) refers to a number of inputs (e.g., linear, curvilinear, or rotational), and N (a positive integer of 1 or greater) refers to a number of outputs (e.g., linear, curvilinear, or rotational) of the EMM (e.g., that are coupled to and control inputs or an external system). Example one-to-three EMMs are illustrated in FIGS. 3 and 5-7 and further described below.

A vehicle with the EMM may be controlled using a vehicle control and interface system (e.g., 100). As previously described, a vehicle control and interface system may be used to control different vehicles through universal mechanisms. The vehicle control and interface system may be integrated with different types of vehicles (e.g., rotorcraft, fixed-wing aircraft, motor vehicles, watercraft, etc.) in order to facilitate operation of the different vehicles using universal vehicle control inputs. In particular, the vehicle control and interface system controls operation of an engine of the vehicle. In some embodiments, the vehicle control and interface system generates a graphical user interface (GUI) provided for display on a computer screen. The GUI may have one button (e.g., a sliding button) that generates an instruction for a flight control computer to begin the engine start up process. Likewise, the vehicle control and interface system can control the engine post start-up and shut down the engine. The vehicle control and interface system interfaces with one or more electro-mechanical actuators (EMAs) (e.g., 130) that provides one or more inputs to the EMM to control one or more of the engine inputs. An engine input can generally be any input to an engine that occurs via an analog actuation (e.g., that occur via engine control cables, linkages, etc.). Engine inputs may be, e.g., fuel cut-off, throttle, Power Turbine Governor (PTG) rotation per minute (RPM), some other analog engine input, or some combination thereof. The EMM can control each of the inputs as a function of the received one or more inputs of the actuators.

FIG. 3 is a diagram of an example EMM 301 that converts a single linear input into three curvilinear outputs (thus, in this example it is a one-to-three EMM). The EMM 301 includes a base 303, a sled 305, a shaft 307, three guide plates (including guide plate 309), and three corresponding levers 315a-c (generally 315) with three corresponding guide pins (including guide pin 327). Translation movement of the sled 305 is the single linear input of the EMM 301 and the resulting movement of the three levers 315a-c is the three curvilinear outputs of the EMM 301. The output coupling locations (e.g., 333) move along an arc, however the arc may have a long radius relative the length moved (in this example) so it is close to a straight line, thus the output motion of the output coupling locations may be referred to as curvilinear instead of rotational. If the radius is smaller relative to the length moved, the output motion of the output coupling locations may be referred to as rotational instead of curvilinear. Components of the EMM 301 may be formed from one or more metals and/or alloys, one or more plastics, some other appropriate material, or some combination thereof. The EMM 301 may include additional, fewer, or different components than as illustrated in FIG. 3. For example, the EMM 301 may include additional or fewer levers, guide plates, rails, channels, receiver assemblies, or some combination thereof.

The base 303 is a rigid frame that secures other components of the EMM 301. More specifically, the base 303 includes a bottom frame (that includes the rail 323 and the holes (not labeled)) and two side frames (that secure the shaft 307). During operation of the EMM 301, the base 303 remains stationary relative to the movable input and output components (e.g., the sled 305, guide plates, guide pins, and levers 315a-c). The base 303 structurally couples (e.g., mounts) the EMM 301 to an external object. For example, the base couples the EMM to a vehicle (e.g., attached to a frame of the vehicle or an engine of the vehicle). In the example of FIG. 3, the base includes holes (not labeled) at the bottom corners that can receive mounting screws or bolts.

The sled 305 is a structure that holds the guide plates in place (e.g., the sled 305 includes a flat plate that supports the guide plates). The sled 305 is coupled to the base 303 and can translate linearly on the base 303 along an axis (labeled sled axis 321 in FIG. 3). In this example, the sled 305 can translate along the axis because it is coupled to a rail 323 of the base 303 and can translate along the rail 323. However other linear movement mechanisms may be used, such as a wheel or cog in a track. In other embodiments, the base 303 may include additional rails (e.g., for increased stability of the sled 305). In some embodiments, the EMM 301 includes multiple sleds that can translate individually along their own dedicated rails (each sled may have its own receiver assembly).

The sled 305 includes a receiver assembly 311 that couples to an external input device, such as an electromechanical actuator (e.g., actuator 130). In the example of FIG. 3, the receiver assembly 311 is at the negative z side of the sled 305, however this is not required (e.g., the receiver assembly 311 may be on the positive z side of the sled 305). By way of example, the receiver assembly 311 may include a mechanical bearing to couple with the external input device. The external input device may apply a force to the sled 305 to move the sled 305 along the sled axis 312 by applying an appropriate force to the sled 305.

The guide plates (including 309) are coupled (e.g., attached) to the sled 305. In embodiments that include multiple sleds, each sled may be attached to one or more guide plates. A guide plate (e.g., 309) is a plate or sheet (e.g., of metal) that includes an open or groove channel (e.g., 339). The channel is in or on the guide plate, and the channel guides movement of an end of a corresponding lever (e.g., one of 315a-c) as the sled moves along the sled axis 312. A channel may be formed by removing (e.g., narrow) portions of material from a guide plate or by adding channel walls to a guide plate. Although the channels can be accessed on both sides of the guide plates (e.g., open) in the example of FIG. 3, this is not required. For example, a channel may be a groove (e.g., not open to other side) in a guide plate. The path (or “geometry”) of a channel affects (1) when rotary motion occurs for its corresponding lever as a function of a rate of linear displacement of the sled, and (2) a movement velocity of the corresponding lever as a function of the rate of linear displacement of the sled. Although the example of FIG. 3 includes guide plates each with a single channel, this is not required. For example, a single guide plate may have multiple channels that each guide movement of a different guide pin (at the ends of different levers).

The levers 315a-c are rigid bars mounted to the shaft 307 (however, each lever is not required to be mounted to the same shaft). In the example of FIG. 3, the shaft 307 is within a hole of each lever 315a-c. The levers 315a-c rotate about the lever axis 325 that runs along a centerline of the shaft 307 and is substantially perpendicular (e.g., within five degrees) to the sled axis 312. The shaft 307 is fixed to the base 303 such that the shaft 307 and the levers 315a-c do not translate along the sled axis 312. Each lever may include a guide pin (e.g., 309) on one end of the lever and an output coupling location (e.g., 333) on the other end of the lever. In the example of FIG. 3, the levers 315a-c are straight (said differently, the “lever angle” formed by (a) a line from the shaft 307 to one end of a lever and (b) a line from the shaft 307 to the other end of the lever is one hundred and eighty degrees). However, this is not required. A lever angle may be greater than or less than one hundred and eighty degrees (e.g., depending on the location of the EMM 301 and the inputs of the external system being controlled by the EMM 301).

A guide pin (e.g., 327) fits within a corresponding channel (e.g., 339) of the corresponding guide plate (e.g., 309). In this manner, for a given lever (e.g., 315a), as the sled 305 translates along the sled axis 312, the guide pin of the lever follows the channel in the guide plate in accordance with the geometry of the channel. Example guide pins include a pin with roller bearing (e.g., a track roller) that rolls as is moves through a channel and a static pin that does not move as it moves through a channel. A pin with a roller bearing may help prevent jamming (e.g., from indentation wear in a channel path). In the example of FIG. 3, if a portion of a channel path is parallel to the sled axis 312, then the corresponding lever does not rotate about the lever axis 325 as the pin moves along that portion. However, if a portion of a channel path is not parallel to the sled axis 312 (e.g., the portion slopes downward or upward), the lever rotates about the lever axis 325 as the pin moves along that portion. Accordingly, the geometry of the channel may control when the lever rotates and a velocity of the lever as a function of the location of the sled on the rail 323 and the rate of linear displacement of the sled.

An output coupling location (e.g., 333) of a lever (e.g., 315a) is a position on the lever where the lever couples (e.g., via a cable or linkage) to an input of an external system (or object), such as an analog input of an engine. In the example of FIG. 3, the output coupling locations include holes, however other coupling mechanisms are possible, such as hooks or latches. In some embodiments, a distance between the output coupling location and the shaft is determined based in part on a target curvilinear (or rotational) velocity of the output coupling location as a function of rate of linear displacement of the sled (the channel path also affects the curvilinear (or rotational) velocity of the coupling location). The positions of the output coupling locations as a function of sled position may differ for different (e.g., engine) inputs of the external system. Thus, among other advantages, different inputs for an external system (e.g., fuel cut-off, throttle, PTG RPM of an engine) may be controlled at differing rates (or the same rates) using a single actuator or multiple actuators (that provides linear movement of the sled 312), such as actuators 130.

In some example embodiments, the EMM 301 is used to control three engine inputs. Thus, the three levers 315a-c control corresponding engine inputs as a function of the levers' rotation about the lever axis 325, which is a function of position and displacement of the sled 305. In one example, rotation of a first lever (e.g., 315a) controls fuel cut-off, rotation of a second lever (e.g., 315b) lever 317 controls throttle, and rotation of a third lever (e.g., 315c) controls PTG RPM. In this example, the channel geometry for each guide plate and the corresponding lever geometry (e.g., length of the lever and lever angle) is specific to each engine input. The lever geometry of each lever 315a-c may be different for other external systems (e.g., other engines). In FIG. 3, the one-to-three EMM 301 is in a “full stroke” position where all three engine inputs are fully open and the sled 305 is at maximum positive z displacement. As such, as the sled displaces in the negative z direction along the sled axis 312 toward an “off” position, the three levers rotate in accordance with their corresponding channel geometries. As such the EMM 301 is able to both start up an engine, control it during operation, and shut the engine down in a controlled manner, thereby mitigating chances of damaging the engine (which may be important during startup of engines in aircraft). Note that, for each lever, there is a continuous range of potential positions between the Off position and the Full Stroke position.

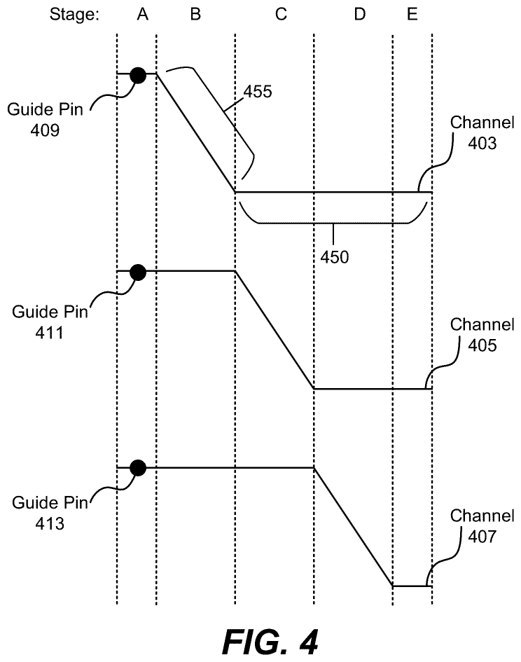

FIG. 4 is a diagram of example channel paths for three guide plates (e.g., the guide plates, e.g., 309, of FIG. 3) of an example EMM (e.g., 301). The diagram includes three channels 403, 405, 407 for guide pins 409, 411, 413 to move along. Horizontal movement in the diagram corresponds to movement of a sled (e.g., 305) along a sled axis (e.g., 312). As the sled moves along the sled axis, the guide pins 409, 411, 413 move along their corresponding channels 403, 405, 406. Due to structure of the example EMM, the pins remain vertically aligned with each other as they move along the channels. If a pin moves along a horizontal portion of a channel (e.g., portion 450), this results in no movement of the corresponding lever. However, if a pin moves vertically (e.g., on a slopped portion of a channel (e.g., portion 455)), this results in movement of the corresponding lever. In the diagram of FIG. 4, the transitions between horizontal portions and sloped portions are sharp. These transition angles may be softened or rounded in practical implementations of an EMM so the guide pins smoothly transition to different portions (e.g., to prevent jamming).

The diagram will now be described in the context of the guide pins moving from left to right along their respective channels. At the start of stage A, the sled is at its start position and all three levers are in their start positions (or “first” positions). In stage A, all three pins move horizontally in the channels, resulting in the corresponding levers staying in their original start positions. In stage B, pins 411 and 413 continue to move horizontally, and pin 409 moves down the slope of channel 403. This results in the levers of pins 411 and 413 staying in their original start positions, and the lever of pin 409 moving from its start position to its end position (or “second” position). In stage C, pins 409 and 413 move horizontally, and pin 411 moves down the slope of channel 405. This results in the lever of pin 409 staying at its end position, the lever of pin 411 moving from its start position to its end position, and the lever of pin 413 staying at its start position. In stage D, pins 409 and 411 move horizontally, and pin 413 moves down the slope of channel 407. This results in the levers of pins 409 and 411 staying in their end positions and the lever of pin 413 moving from its start position to its end position. In stage E, all three pins move horizontally, resulting in the corresponding levers staying in their end positions. At the end of stage E, the sled is at an end position.

Thus, in the example of FIG. 4, the three corresponding levers, e.g., 315a-c, move in sequence. First, the lever of pin 409 moves to its end position while the other two levers stay in their current positions. After the lever of pin 409 reaches its end position, the lever of pin 411 then moves to its end position, while the other two levers stay in their current positions. After the lever of pin 411 reaches its end position, the lever of pin 413 then moves to its end position, while the other two levers stay in their current positions. Similarly, by reversing the movement direction of the sled, the corresponding levers sequentially return to their start positions (in reverse order). Among other advantages, the channel geometry arrangement of FIG. 4 may be used to control three different external system (e.g., engine) inputs sequentially using a single actuator (the specific sequence may be important for a given external system). For example, to conduct a vertical takeoff for a rotorcraft, an EMM may be used to: (1) open the fuel valve of the engine (via a first lever moving), then (2) increase the throttle from ground idle to flight idle (via a second lever moving), and then (3) adjust the power turbine governor (via a third lever moving). Similarly, the rotorcraft aircraft can perform a vertical landing by using the EMM to perform the opposite operations in the reverse order (e.g., (1) adjust the power turbine governor, then (2) decrease the throttle from flight idle to ground idle, and then (3) close the fuel valve of the engine).

The channel paths illustrated in FIG. 4 are examples though and other channel paths can be used for other EMMs (e.g., depending on the external inputs of the external system to be controlled by the EMM). For example, the path geometries can be changed such that: two or more levers move at the same time, one or more levers move at different rates (by modifying the slop of the channel or the length of the corresponding lever), there is a delay between one lever reaching its end position and another lever beginning to move from its start position, a channel path may slope up or down (or both), or some combination thereof. Many different choreographies between the levers are possible by adjusting the channel paths.

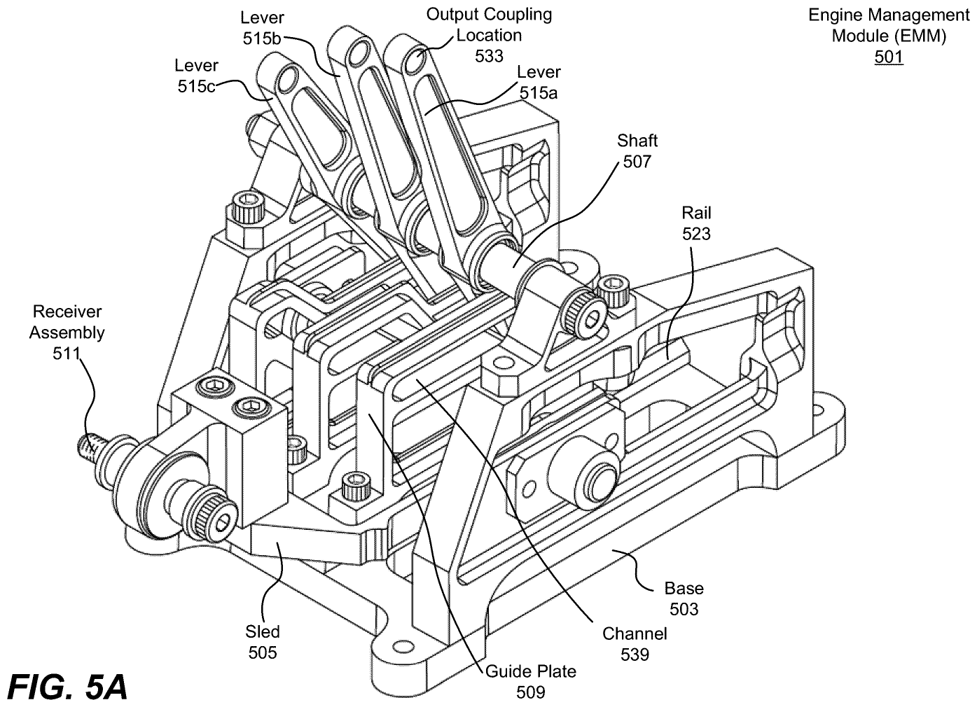

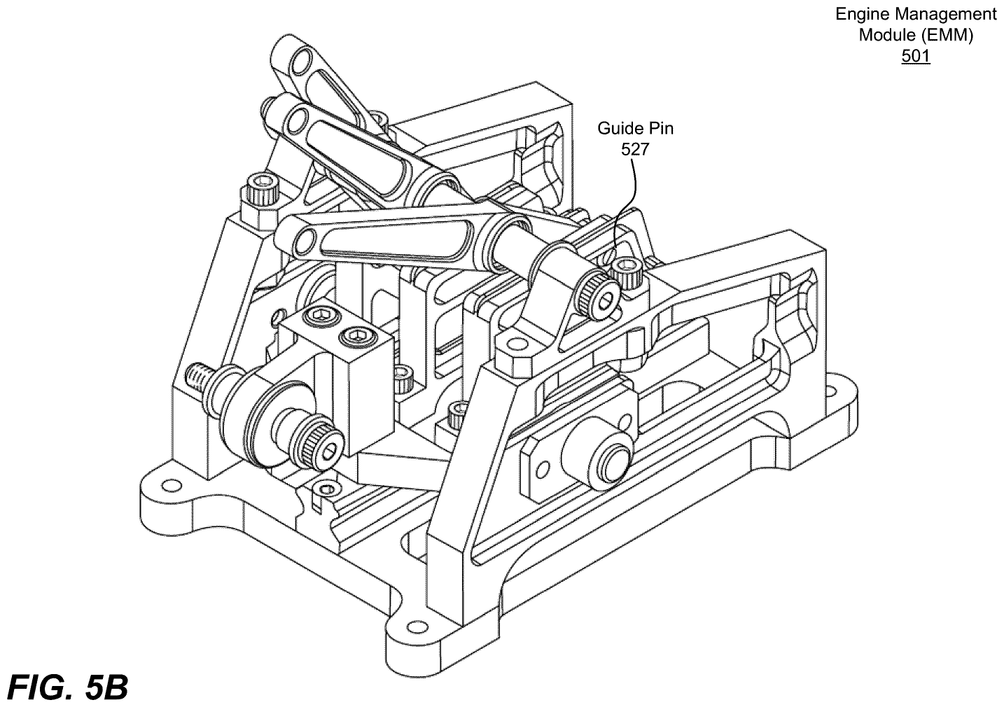

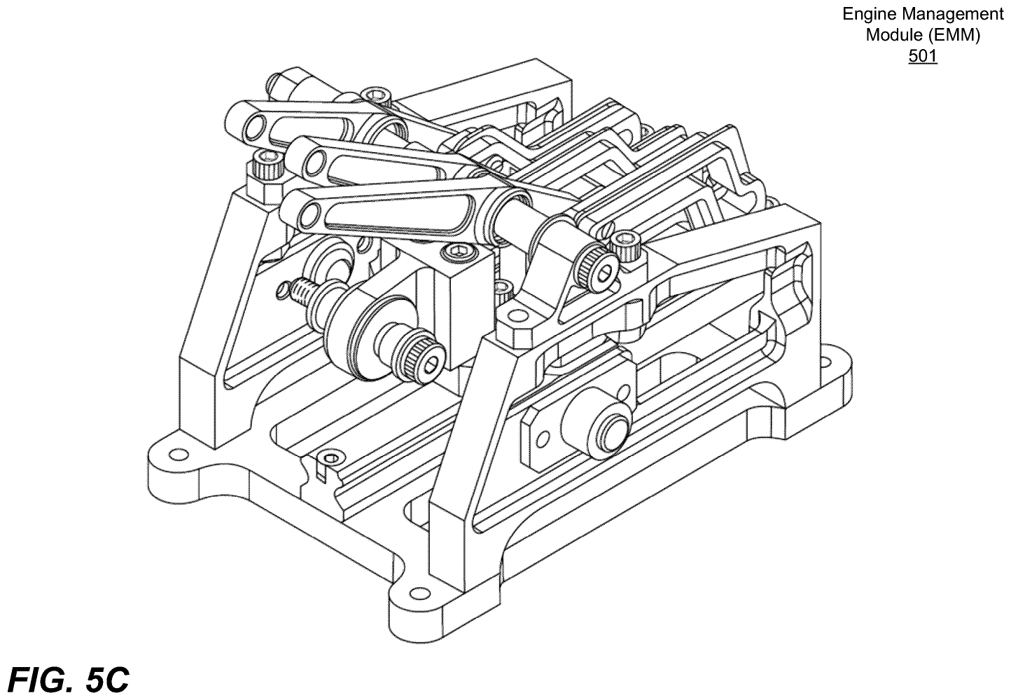

FIGS. 5A-5C (“FIG. 5” collectively) are diagrams of a second example EMM 501 that converts a single linear input into three curvilinear outputs (thus, it is a one-to-three EMM). More specifically, FIG. 5 illustrates an EMM 501 with a sled 505 in different positions. Similar to the EMM 301 in FIG. 3, the EMM 501 in FIG. 5 includes a base 503 with a rail 523, a sled 505 with a receiver assembly 511, a shaft 507, three guide plates (including guide plate 509), and three corresponding levers 515a-c (generally 515) with three corresponding guide pins (including guide pin 527) and output coupling locations (including coupling location 533). Components of the EMM 501 may be formed from one or more metals and/or alloys, one or more plastics, some other appropriate material, or some combination thereof. The sled 505 can slide along the rail 523 to rotate the levers 515a-c about the shaft 507 according to the channels in the guide plates. The sled 505 may slide along the rail 523 due to an actuator coupled to the receiver assembly 511 moving the sled 505. As mentioned with respect to FIG. 3, the output coupling locations (e.g., 533) move along an arc, however the arc may have a long radius relative the length moved so it is close to a straight line, thus the output motion of the output coupling locations may be referred to as curvilinear instead of rotational. If the radius is smaller relative to the length moved, the output motion of the output coupling locations may be referred to as rotational instead of curvilinear). The EMM 501 may include additional, fewer, or different components than as illustrated in FIG. 5. For example, the EMM 501 may include additional or fewer levers, guide plates, rails, channels, receiver assemblies, or some combination thereof.

FIG. 5A-5C will be described in the context of the sled 505 starting in an initial position illustrated in FIG. 5A and moving to an end position illustrated in FIG. 5C. In FIG. 5A, the sled 505 is in the initial position at or near a first end of the rail 523. The levers 515a-c are in initial rotational positions based on the channels in the guide plates (this may be referred to as an off position). In FIG. 5C, the sled 505 is in the end position at an opposite end of the rail 523. Thus, the levers 515a-c are in corresponding end rotational positions based on the channels (this may be referred to as a full-stroke position). In FIG. 5B, the sled 505 is in an intermediate position between the initial and end positions (this may be referred to as a mid-stroke position). Due to the channels, lever 515a is at an end rotational position, lever 515c is still in its initial rotational position, and middle lever 515c is between its initial and end rotational positions.

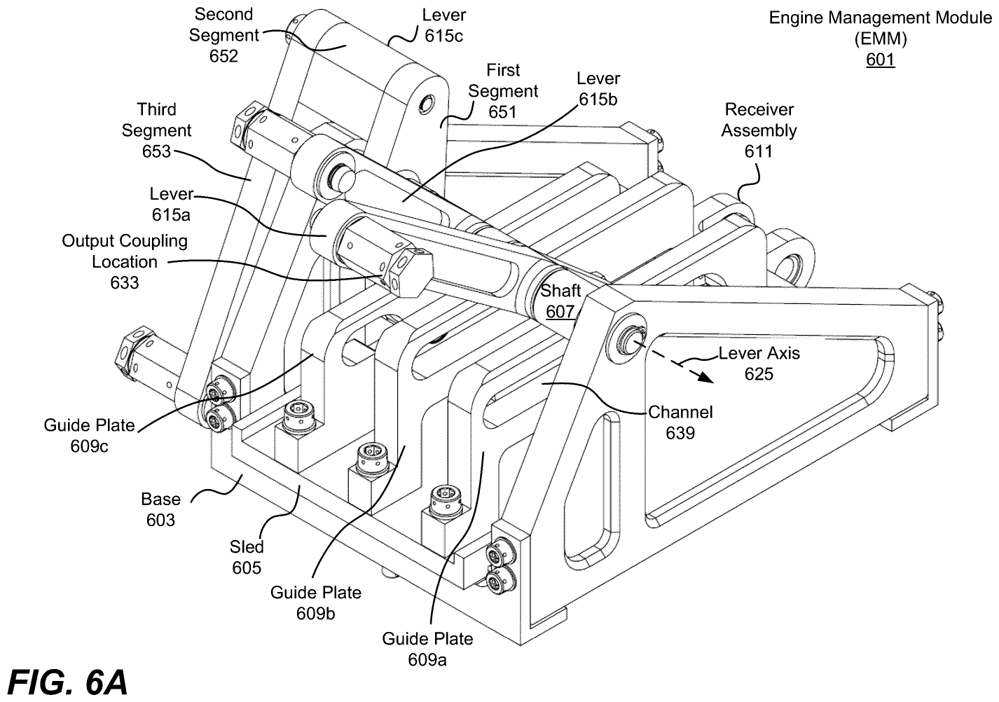

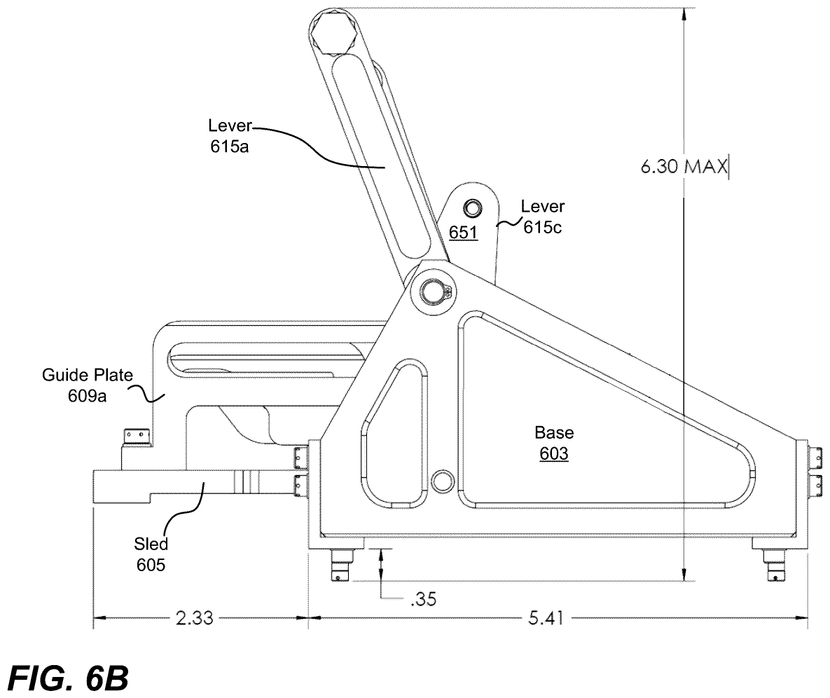

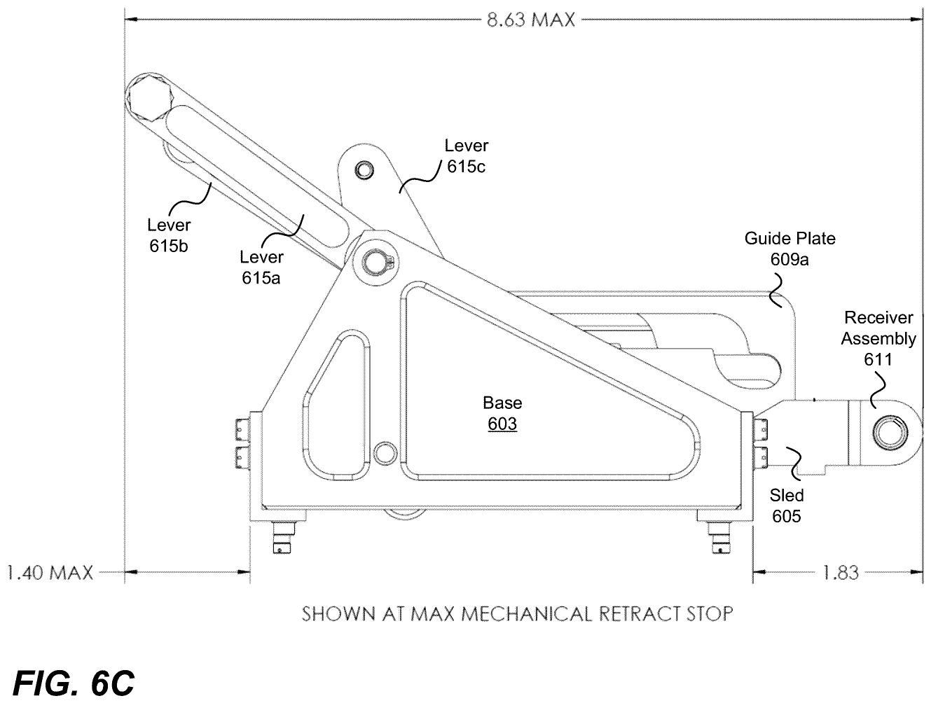

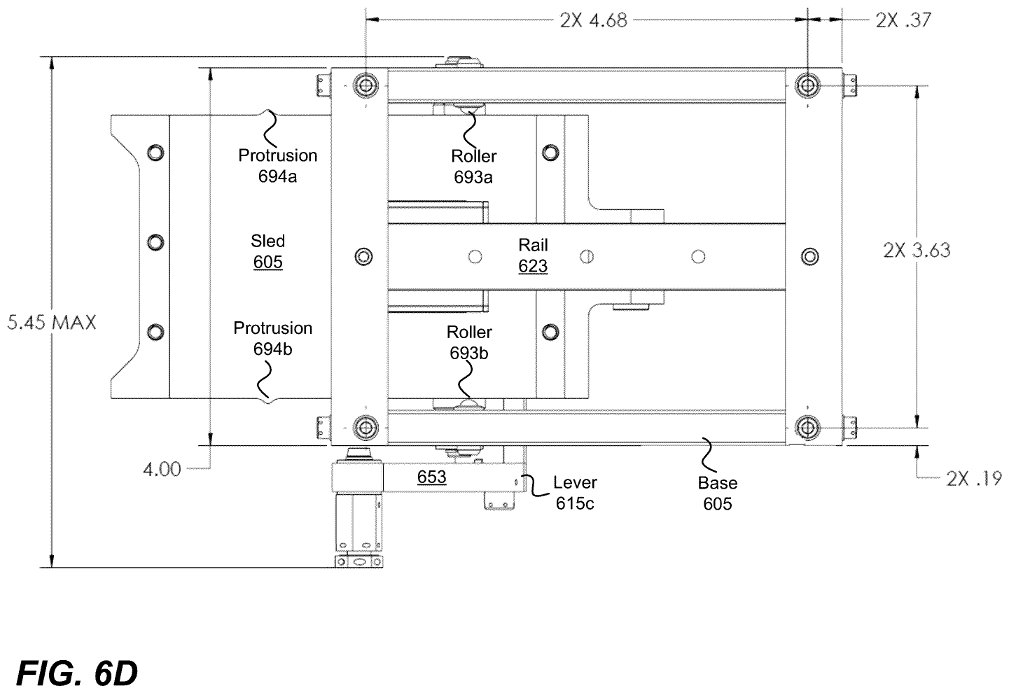

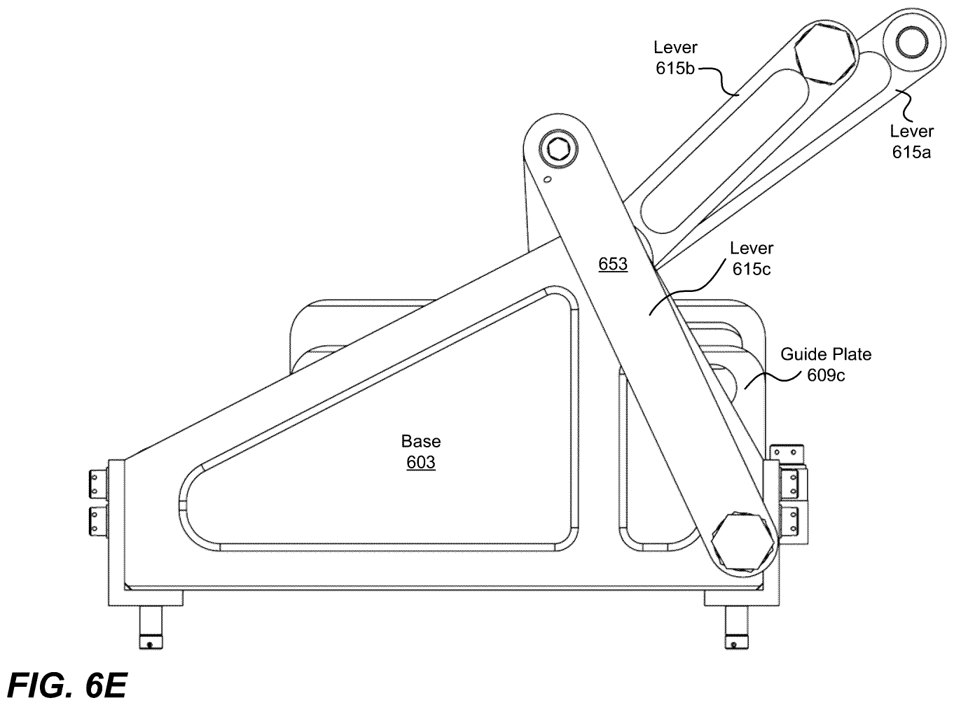

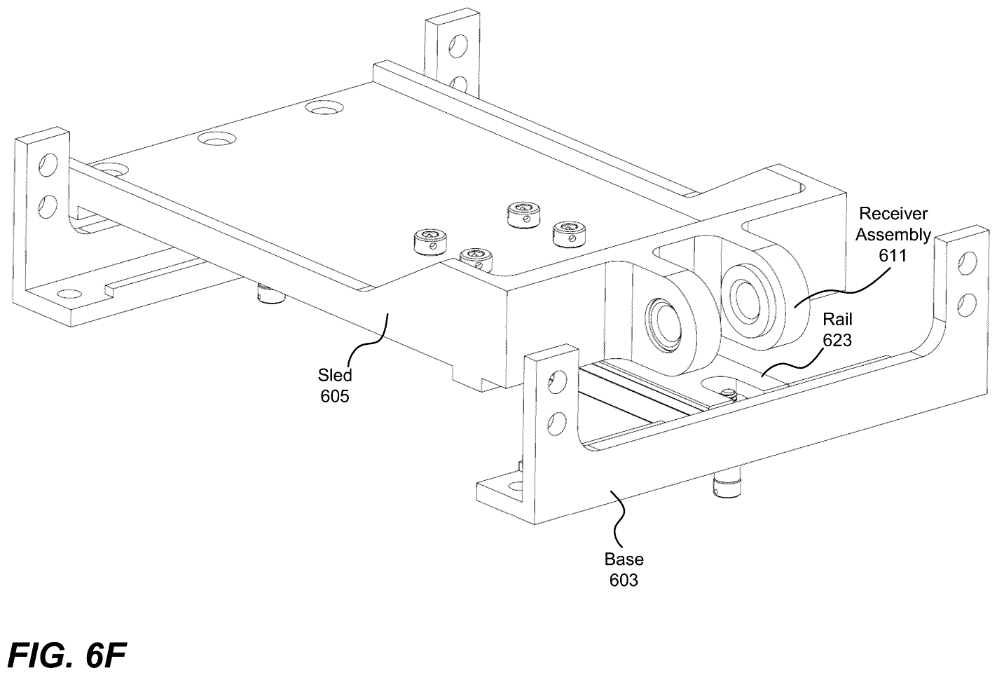

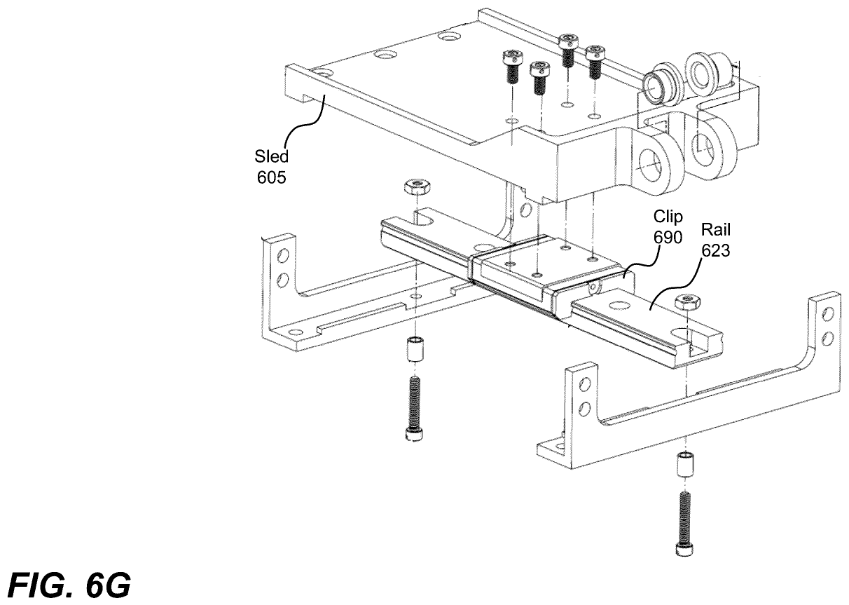

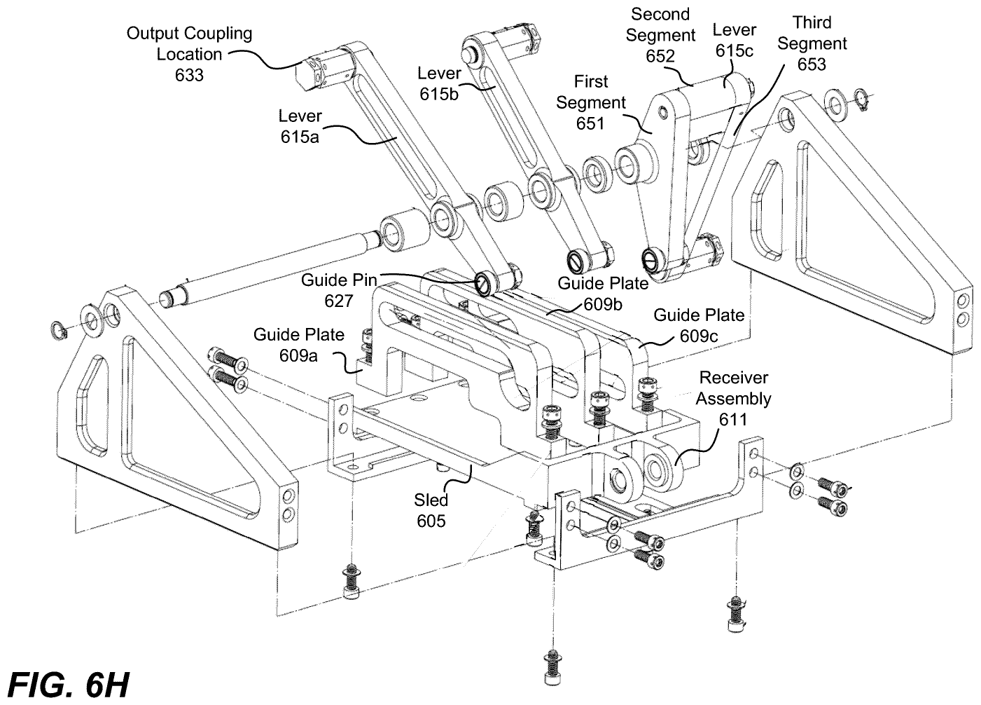

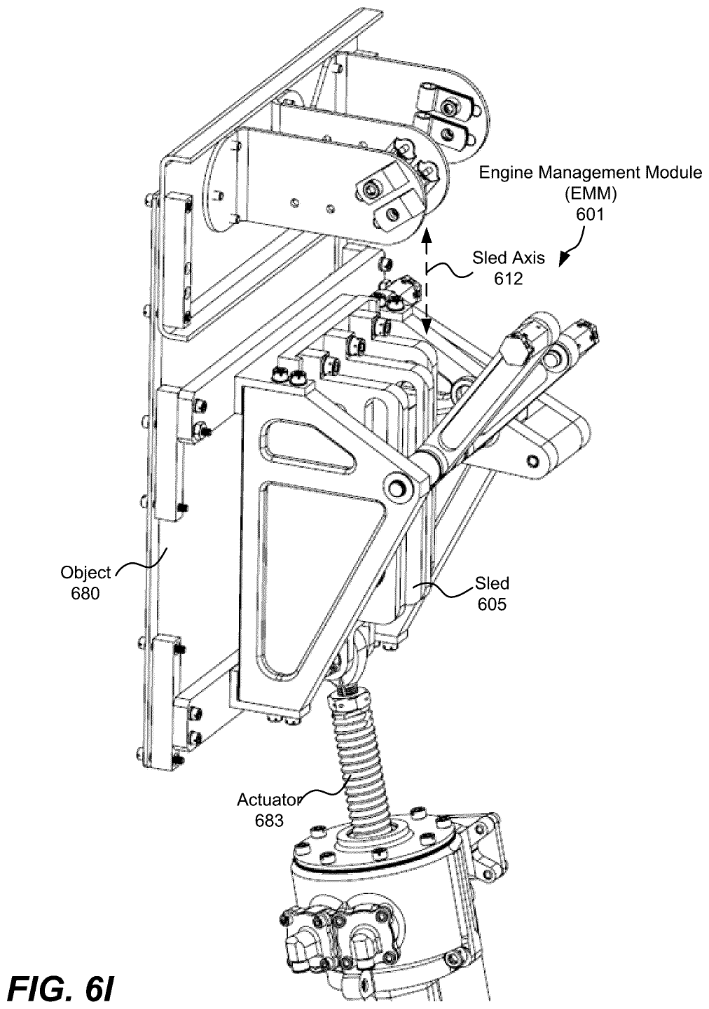

FIGS. 6A-6I (collectively FIG. 6) are diagrams of a third example EMM 601 that converts a single linear input into three curvilinear outputs (thus, it is a one-to-three EMM). Similar to the EMM 301 in FIG. 3 and the EMM 501 in FIG. 5, the EMM 601 in FIG. 6 includes a base 603 with a rail 623 (see FIG. 6G), a sled 605 with a receiver assembly 611, a shaft 607, three guide plates 609a-c (generally 609), and three corresponding levers 615a-c (generally 615) with three corresponding guide pins (including guide pin 627 (labeled in FIG. 6H)) and output coupling locations (including coupling location 633). Components of the EMM 601 may be formed from one or more metals and/or alloys, one or more plastics, some other appropriate material, or some combination thereof. As mentioned with respect to FIGS. 3 and 5, the output coupling locations (e.g., 633) move along an arc, however the arc may have a long radius relative the length moved so it is close to a straight line, thus the output motion of the output coupling locations may be referred to as curvilinear instead of rotational. If the radius is smaller relative to the length moved, the output motion of the output coupling locations may be referred to as rotational instead of curvilinear). Similar to the EMMs in FIGS. 3 and 5, the sled 605 can slide along the rail 623 to rotate the levers 615a-c about the shaft 607 according to the channels in the guide plates 609a-c. The sled 605 may slide along the rail 623 due to an actuator (e.g., 130, 683) coupled to the receiver assembly 611 moving the sled 605. The EMM 601 may include additional, fewer, or different components than as illustrated in FIG. 6. For example, the EMM 601 may include additional or fewer levers, guide plates, rails, channels, receiver assemblies, or some combination thereof.

FIG. 6A is a perspective diagram of the EMM 601. FIG. 6B is a first side view of the EMM 601 with the sled 605 in a first position. FIG. 6C is the first side view of the EMM 601 with the sled 605 in a second position. FIG. 6D is a bottom view of the EMM 601. FIG. 6E is a second side view of the EMM 601. FIG. 6F is a diagram of the sled 605 and part of the base 603 of the EMM 601. FIG. 6G is an exploded view of the components in FIG. 6F. FIG. 6H is an exploded view of the EMM 601. FIG. 6I is a diagram of the EMM 601 coupled to an external object 680 and actuator 683. Note that some of the figures of FIG. 6 include dimensions in inches. There are for example purposes only and other embodiment EMMs may have different dimensions than those given.

Lever 615c of EMM 601 is a reverse lever that extends over the side of the base 603. The reverse lever 615c includes three segments. The first segment 651 is mounted to the shaft 607 and extends upward in a first direction (e.g., similar to other straight levers e.g., 615a-b). The second segment 652 is coupled to the first segment 651 and extends laterally in a second direction different than the first direction (e.g., substantially perpendicular to the first direction and/or substantially parallel to the lever axis 625). The third segment 653 is coupled to the second segment 652 and extends in a third direction different than the second direction (e.g., substantially perpendicular to the second direction). In the example of FIG. 6, the third direction is substantially parallel to the first direction (however this is not required). Note that other embodiments of the reverse lever 615c are possible. For example, the second segment 652 may be curved such that the reverse lever 615c forms a “U” shape. Note that “substantially” parallel or perpendicular as used in this paragraph refers to within five degrees of perfectly parallel or perpendicular. Furthermore, note that EMMs in FIGS. 3 and 6 may be modified to include a revers lever.

The output coupling location of the reverse lever 615c is below the shaft 607 instead of above it. Thus, if the first segment 651 moves (curvilinear or rotational movement) backwards as the sled 605 translates, the output coupling location of the reverse lever 615c moves (curvilinear or rotational movement) forward (or another direction depending on the angle between the first direction of the first segment 651 and the third direction of the third segment 653). More generally, the output coupling location of the reverse lever 615c enables movement in an opposite direction compared to a straight lever (e.g., lever 615a-b), assuming similar channel paths. More specifically, if lever 615 rotates backward as the sled 605 translates, the reverse lever 615c may rotate forward, assuming similar channel paths. Among other advantages, the ability to use reverse levers and straight levers on EMMs allows EMMs to apply external inputs to a larger variety of external systems (e.g., engines). For example, the EMM 601 may be used to apply external inputs to an engine that requires two pulling motions (e.g., curvilinear or rotational motions away from the engine) and a pushing motion (e.g., curvilinear or rotational motion toward the engine).

Instead of a reverse lever (e.g., 615c), an EMM (e.g., 301, 501, 601) may include a straight lever coupled to a guide plate with channel path that guides the lever to rotate in a reverse direction as the sled translates. For example, referring to FIG. 4, any of the channels may be flipped along a horizontal axis to change the rotation direction of the corresponding lever. For example, if channel 405 is flipped, in stage A the lever of pin 411 is at the second position (instead of the first position). In stage C, the lever of pin 411 rotates to the first position (instead of rotating to the second position). In stage E, the lever of pin 411 remains in the first position (while the other levers remain in their second positions).

In FIG. 6I, the EMM 601 is vertically mounted to an external object 680. Said, differently, the EMM 601 is oriented such that gravity is applying a force to the sled 605 along the sled axis 612. Among other advantages, if an emergency situation occurs during operation of the external system (e.g., the actuator 683 malfunctions, loses power, or becomes uncoupled to the receiver assembly 611), the sled 612 stays at the bottom position (or moves to the bottom position if it is not already there) due to the force of gravity on the sled 612. This may be advantageous when the external system (controlled by the EMM 601) should have specific inputs during an emergency situation. For example, if the EMM 601 is controlling inputs to an engine of a rotorcraft and the levers 615a-c are controlling the fuel valve and throttle of the engine, if an emergency situation occurs, the fuel valve may remain open and the throttle may remain on (assuming those correspond to the bottom position of the sled 605), thus enabling the pilot to continue controlling the aircraft even during the emergency situation. Among other advantages, this mounting orientation of the EMM 601 may also reduce the number of redundant channels required for the actuator 683, which may result in reducing the cost of the actuator 683.

In addition to, or alternative to, vertically mounting an EMM, an EMM may include a mechanism system that, after the sled moves forward past a threshold point, the mechanism system prevents the sled from moving backward past the threshold point (e.g., unless certain conditions are met). For example, the rail includes a (e.g., a spring-loaded) knob (or switch or gear) that allows movement of the sled over the knob when the sled moves along one direction. However, the knob engages with the sled if the sled modes along the opposite direction, thus preventing the sled from moving over the knob in the opposite direction (e.g., if an emergency situation occurs). The knob may be controlled (e.g., electromechanically controlled) to retract under normal operating conditions though.

Another example (optional) mechanism system is illustrated in FIG. 6D with respect to EMM 601. The mechanism system is a passive system that includes two (e.g., spring loaded) rollers 693a-b and two corresponding protrusions 694a-b (additional or fewer rollers/protrusions are also possible). The rollers 693a-b face each other and are located on inward facing surfaces of the base 605 (e.g., on inward surfaces of side frame portions of the base 605). The protrusions 694a-b are on sides of the sled 605 and extend outward away from each other (in other embodiments, the protrusions 694a-b may be on the base 605 and the rollers 693a-b may be on the sled 605). The protrusions 694a-b are aligned with each other such that, when the sled 605 moves on the sled axis (e.g., from left to right in FIG. 6D), the protrusions 694a-b can interact with the rollers 693a-b. This creates an interaction point (also “threshold point”) along the sled axis. To move the sled 605 past the interaction point (said differently, to move the protrusions 694a-b past the rollers 693a-b), a higher force on the sled 605 may be required (e.g., by an actuator coupled to the receiver assembly 611). Thus, if an emergency situation occurs, the sled 605 may be prevented from moving past the interaction point, even in the presence of vibrations or the force of gravity. For example, if the EMM 601 is controlling inputs to an engine of a rotorcraft and the levers 615a-c are controlling the fuel valve and throttle of the engine, if an emergency situation occurs, the fuel valve may remain open and the throttle may remain on (due to the protrusions/rollers preventing the sled 605 from sliding past the interaction point), thus enabling the pilot to continue controlling the aircraft even during the emergency situation.

The above descriptions with respect to FIGS. 3-6 generally describe EMMs with linear inputs and rotational/curvilinear outputs. The following descriptions describe EMMs with rotational inputs and linear outputs.

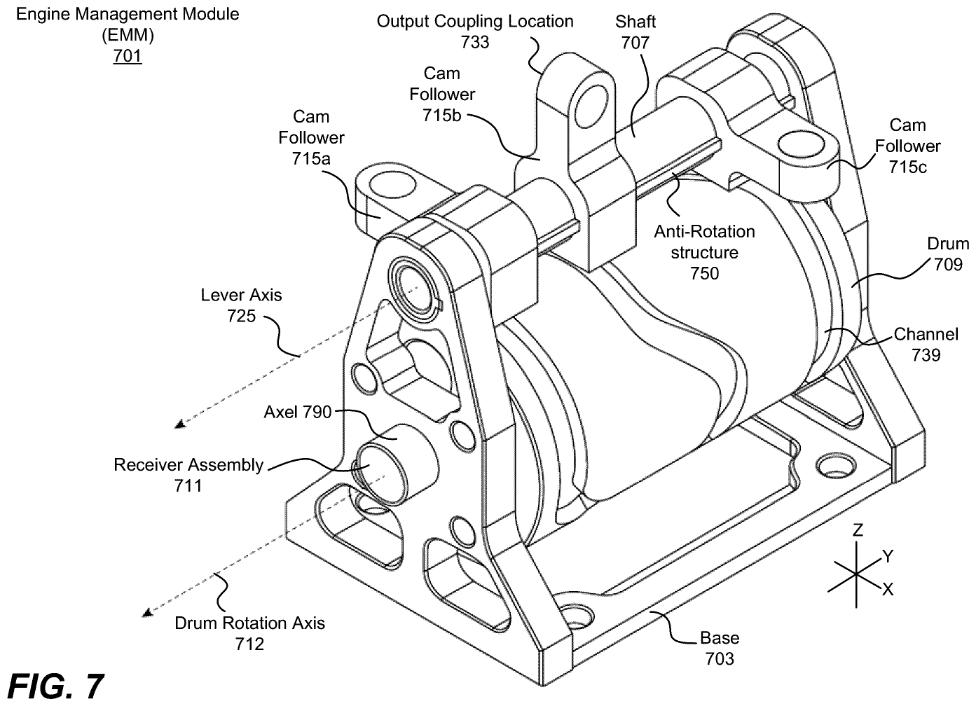

FIG. 7 is a perspective diagram of an example EMM 701 that converts a single rotational input into three linear outputs (thus it is a one-to-three EMM). The EMM 701 includes a base 703, a drum 709 with three channels (including channel 739), a shaft 707, and three cam followers 715a-c (generally 715) (also “levers”) on the shaft 707. Rotational movement of the drum 709 about the rotation axis 712 is the single rotational input of the EMM 701 and the resulting translational movement of the cam followers 715a-c on the shaft 707 is the three linear outputs of the EMM 701. Components of the EMM 701 may be formed from one or more metals and/or alloys, one or more plastics, some other appropriate material, or some combination thereof. The EMM 701 may include additional, fewer, or different components than as illustrated in FIG. 7. For example, the EMM 701 may include additional or fewer cam followers, channels, receiver assemblies, or some combination thereof. Additionally, or alternatively, the EMM 701 may include additional drums, shafts, or some combination thereof.

In the example of FIG. 7, the three cam followers 715a-c are located along the lever axis 725 and translate (and in some cases rotate) as a function of an amount of rotation of the drum 709. The lever axis 725 and the drum rotation axis 712 are substantially parallel (e.g., within five degrees). The drum 709 includes a channel for each cam follower 715a-c, and each cam follower 715a-c is coupled to its respective channel via a guide pin (not seen in FIG. 7) such that as the drum 709 rotates, the cam followers 715a-c translate along the shaft 707. Thus, among other advantages, different inputs for an external system (e.g., fuel cut-off, throttle, PTG RPM of an engine) may be controlled at differing rates (or the same rates) using a single actuator or multiple actuators (that provides rotational movement of the drum 709).

The base 703 is a rigid frame that secures other components of the EMM 701. For example, the 703 holds the shaft 707 and drum 709 in place relative to each other so that the cam followers 715a-c remain coupled to the drum 709. The base 703 also couples (e.g., mounts) the EMM 701 to an external object. For example, the base 703 couples the EMM 701 to a vehicle (e.g., attached to a frame of the vehicle or an engine of the vehicle). In the example of FIG. 7, the base 703 includes holes (not labeled) near the bottom corners that can receive mounting screws or bolts.

The drum 709 is coupled to the base 703. The drum 709 is a cylinder that rotates about the central axis of the cylinder (i.e., the rotation axis 712) via an axel 790 that passes through the drum 709 and includes ends coupled to the base 703. In some embodiments, the EMM 701 includes multiple drums that rotate about the rotation axis 712 (e.g., a drum for each channel). The drum 709 includes a receiver assembly 711 that couples to an external input device, such as an electromechanical actuator. The external input device can rotate the drum 709 about the rotation axis 712 by applying an appropriate force.

The cam followers 715a-c are coupled to the shaft 707, however each cam follower 715a-c is not required to be mounted to the same shaft. For example, the EMM 701 may include an additional shaft with a cam follower coupled to a channel (e.g., since shaft 707 is above the drum 709, the additional shaft may be lateral to the drum 709 (along the x-axis)). Each cam follower 715a-c wraps entirely around the shaft 707, however this is not required. Each cam follower 715a-c includes a guide pin that engages with (or protrudes into) the corresponding channel and an output coupling location (e.g., 733). Example guide pins include a pin with roller bearing (e.g., a track roller) that rolls as is moves through a channel and a static pin that does not move as it moves through a channel. A pin with a roller bearing may help prevent jamming (e.g., from indentation wear in a channel path). Although each cam follower 715a-c is coupled to a different channel in the example of FIG. 7, this is not required. For example, a cam follower may include a pin that extends to another channel. In another example, the EMM 701 includes an additional shaft with a cam follower coupled to a channel shared with a cam follower on shaft 707.

The shaft 707 is fixed to the base 703 and includes an anti-rotation structure 750 that prevents the shaft 707 and the cam followers 715a-c from rotating about the lever axis 725 (within a desired tolerance e.g., less than five degrees). The anti-rotation structure 750 is a protrusion that extends along the length of the drum 709. The cam followers 715a-c and the base 703 include grooves that engage with the protrusion to prevent rotation about the lever axis 725 (also the central axis of the shaft).

The channels are groves or tracks in or on the external surface of the drum 709. The channels guide movement of the cam followers 715a-c along the shaft 707 (along lever axis 725) as the drum 709 rotates. A channel may be formed by removing portions of material from the drum 709 or by adding walls or a track to the drum 709. The path (or “geometry”) of a channel affects when the corresponding cam follower (e.g., 715b) translates and the velocity of that movement as a function of the rotational position and rotation rate of the drum 709. In the example of FIG. 7, if a portion of a channel is straight and perpendicular to the rotation axis 712, then the corresponding cam follower (e.g., 715b) does not translate along the lever axis 725 as the guide pin moves along that portion. However, if a portion of a channel is not perpendicular to the rotation axis 712 (e.g., it slops towards an end of the drum 709), then the corresponding cam follower translates along the rotation axis 712 as the pin moves along that portion.

An output coupling location (e.g., 733) of a cam follower (e.g., 715b) is a position on the cam follower where the cam follower couples (e.g., via a cable or linkage) to an input of an external system, such as an analog input of an engine. In the example of FIG. 7, the output coupling locations include holes, however other coupling mechanisms are possible, such as hooks or latches. In the example of FIG. 7, each of the output coupling locations protrude along a different direction. More specifically, the output coupling location of cam follower 715a extends along the negative x direction, the output coupling location 733 of the middle cam follower 715b extends along the positive z direction, and the output coupling location of cam follower 715c extends along the positive x direction. Among other advantages, these different directions enable coupling to an external system without the coupling mechanisms (e.g., cables) interfering with each other.

In some embodiments, the EMM 701 is used to control three engine inputs. Thus, the three cam followers 715a-c control corresponding engine inputs as a function of the translation along the rotation axis 712, which is a function of the position and displacement of the drum 709. Channel geometry and the corresponding cam follower geometry may be specific to each engine input. For each cam follower, there is a continuous range of potential positions between, for example, an off position and a full stroke position.

The EMM 701 may include a mechanism system that, after the drum 709 rotates past a threshold point, the mechanism system prevents the drum 709 from rotating backward past the threshold point (e.g., unless certain conditions are met). Example mechanism systems were previously described with respect to FIG. 6.

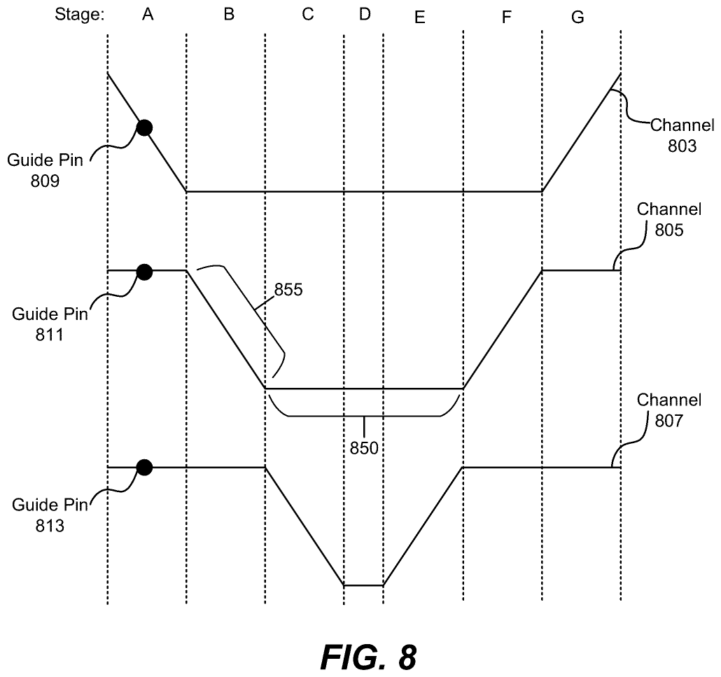

FIG. 8 is a diagram of example channel paths on a drum (e.g., 709) of an example EMM (e.g., 701). The diagram includes three channels 803, 805, 807 for guide pins 809, 811, 813 to move along. Horizontal movement in the diagram corresponds to rotational movement of the drum (e.g., 709) about a rotation axis (e.g., 712). As the drum rotates, the guide pins 809, 811, 813 move along their corresponding channels 803, 805, 806. Due to structure of the example EMM, the pins remain vertically aligned with each other as they move along the channels. If a pin moves along a horizontal portion of a channel (e.g., portion 850), this results in no movement of the corresponding cam follower. However, if a pin moves vertically (e.g., on a slopped portion of a channel (e.g., portion 855)), this results in movement of the corresponding cam follower. In the diagram of FIG. 8, the transitions between horizontal portions and sloped portions are sharp. These transition angles may be softened or rounded in practical implementations of an EMM so the guide pins smoothly transition to different portions (e.g., to prevent jamming).

The diagram will now be described in the context of the guide pins moving from left to right along their respective channels. In stage A, pins 811 and 813 move horizontally, and pin 809 moves down the first slope of channel 803. This results in the cam followers of pins 811 and 813 staying in their first positions, and the cam follower of pin 809 moving from its first position to a second position. In stage B, pins 809 and 813 move horizontally, and pin 811 moves down the first slope of channel 805. This results in the cam follower of pin 809 staying at its second position, the cam follower of pin 811 moving from its first position to its second position, and the cam follower of pin 813 staying at its first position. In stage C, pins 809 and 811 move horizontally, and pin 813 moves down the first slope of channel 807. This results in the cam followers of pins 809 and 811 staying in their second positions and the cam follower of pin 813 moving from its first position to its second position. In stage D, all three pins move horizontally, resulting in the corresponding cam followers staying in their second positions.

Stages E-G are similar to stages A-C but in reverse order (and the pins move from second to first positions). In stage E, pin 813 moves up the second slope of channel 807, resulting in its cam follower moving from its second position to its first position. In stage F, pin 811 moves up the second slope of channel 805, resulting in its cam follower moving from its second position to its first position. In stage G, pin 809 moves up the second slope of channel 803, resulting in its cam follower moving from its second position to its first position. Because the drum is circular, the ending channel positions of stage G may connect to the starting channels positions of stage A. However, this is not required. For example, the diagram may terminate at Stage D. Thus, to return the pins to their first positions, the drum may be rotated in the opposite direction.

Thus, in the example of FIG. 8, the three corresponding cam followers move in sequence. First, the cam follower of pin 809 moves to its second position while the other two cam followers stay in their current positions. After the cam follower of pin 809 reaches its second position, the cam follower of pin 811 then moves to its second position, while the other two cam followers stay in their current positions. After the cam follower of pin 811 reaches its second position, the cam follower of pin 813 then moves to its second position, while the other two cam followers stay in their current positions. By continuing along the diagram, the corresponding cam followers sequentially return to their start positions (in reverse order). Among other advantages, the channel geometry arrangement of FIG. 8 may be used to control three inputs of an external system (e.g., engine) sequentially using a single actuator (the specific sequence may be important for a given external system). For example, to conduct a vertical takeoff for a rotorcraft, an EMM may be used to: (1) open the fuel valve of the engine (via a first cam follower moving to its second position), then (2) increase the throttle from ground idle to flight idle (via a second cam follower moving to its second position), and then (3) adjust the power turbine governor (via a third cam follower moving to the second position). Similarly, the rotorcraft can perform a vertical landing by using the EMM to perform the opposite operations in the reverse order by continuing to rotate the drum in the same direction or reversing the rotation direction (e.g., (1) adjust the power turbine governor, then (2) decrease the throttle from flight idle to ground idle, and then (3) close the fuel valve of the engine).

The channel paths illustrated in FIG. 8 are examples though and other channel paths can be used for other EMMs (e.g., depending on the external inputs of the external system to be controlled by the EMM). For example, the path geometries can be changed such that: two or more cam followers move at the same time, one or more cam followers move at different rates (by modifying the slop of the channel or the length of the corresponding cam follower), there is a delay between a first cam follower reaching its second position and a second cam follower beginning to move from its first position, or some combination thereof. Many different choreographies between the cam followers are possible by adjusting the channel paths.

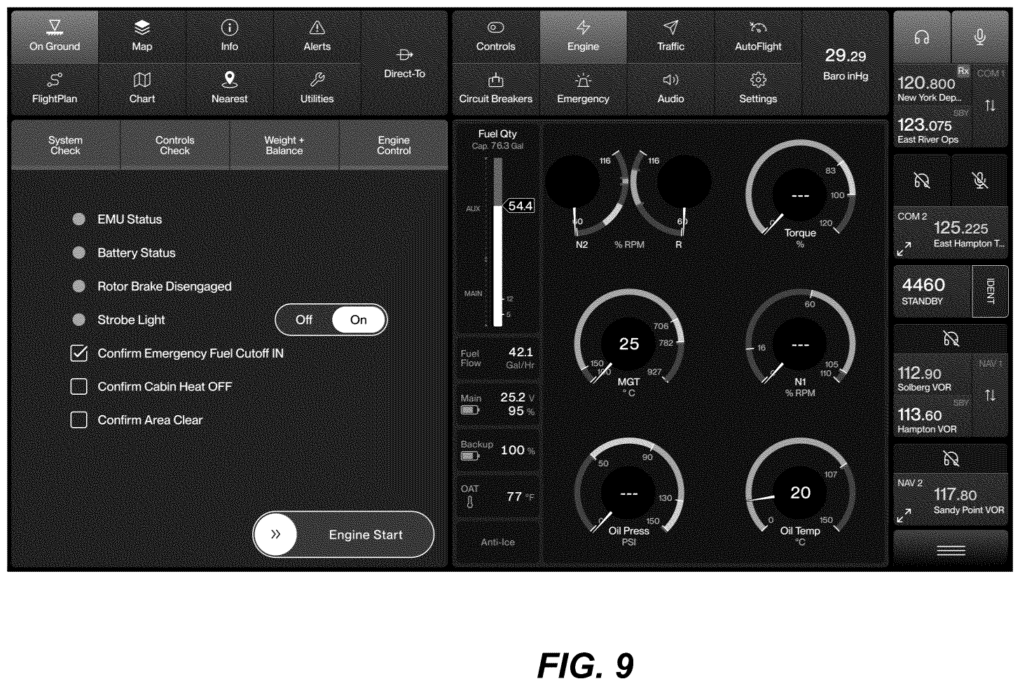

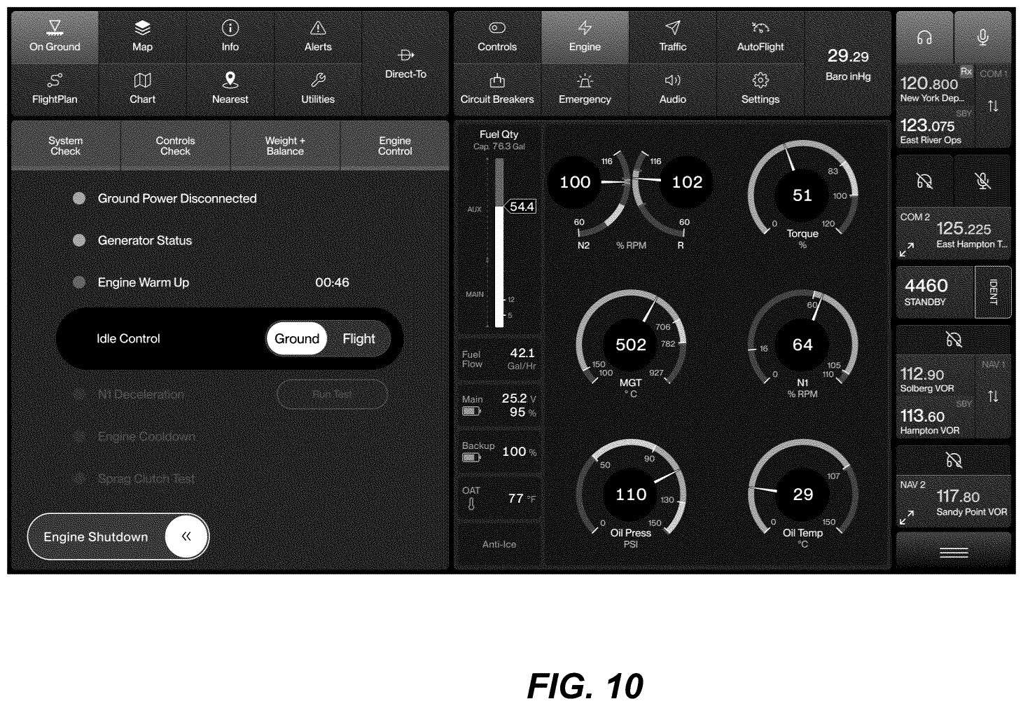

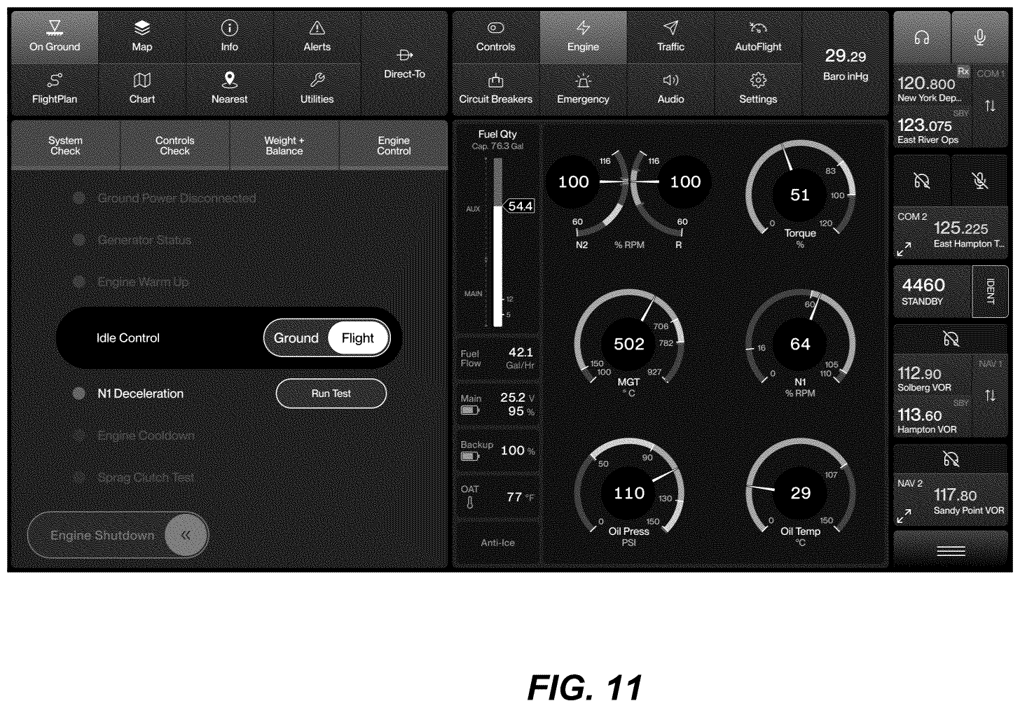

FIGS. 9-11 are example user interfaces that may be configured and provided for display on a screen (e.g., via 210, 220) to be viewed by an operator of a rotorcraft with an EMM that controls inputs of the rotorcraft engine. The user interfaces also may be configured and provided for display on a screen to enable the operator to control the EMM. For example, in the “idle control” indicator with “ground” and “flight” selection options (on the right hand side of FIGS. 10 and 11). If current selection is “ground” and the operator selects (e.g., via touching the screen) “flight,” this may result in an actuator (e.g., 130, 683) coupled to an EMM applying a linear force to a sled (e.g., 305) or a rotational force to a drum (e.g., 709), such that a lever of the EMM increases the engine throttle from ground idle to flight idle. Similarly, if the operator selects “ground,” this may result in the actuator applying a force in the opposite direction such that the lever of the EMM decreased the engine throttle from flight idle to ground idle. In another example, an operator may select “Engine Start”, whereby the computers will begin a startup sequence including signaling a starter generator to begin rotating the engine, monitoring an RMP of a gas generator turbine, turning on the ignitors, and when conditions are met, moving the EMM to introduce fuel.

### Additional Engine Management Module (EMM) Examples

Although FIGS. 3-8 (and their descriptions) provide example EMMs, the below paragraphs describe additional example EMMs. The EMMs described below may include and/or omit features illustrated in FIG. 3-8 (or their descriptions) and/or include features that are in addition to or alternative to the features illustrated in FIGS. 3-8 (and their descriptions). In the below descriptions, “substantially” parallel or perpendicular refers to within five degrees of perfectly parallel or perpendicular.

Some aspects relate to a device including: a base (e.g., 303, 503, 603); a shaft coupled to (e.g., fixed to) the base (e.g., 307, 507, 607); a sled (e.g., 305, 505, 605) coupled to the base, the sled configured to translate (e.g., move along a straight line) along a sled axis (e.g. 312, 612); a first guide plate (e.g., 309, 509, 609a) coupled to the sled, the first guide plate including a first channel (e.g., 339, 539, 639); and a first lever (e.g., 315, 515, 615) coupled to the shaft, the first lever having a first end and a second end, the first end including a first guide pin (e.g., 327, 527, 627) that is positioned within the first channel such that as the sled translates along the sled axis, the first guide pin moves along the first channel to cause the second end of the first lever to rotate about the shaft (e.g., see levers 515a-b rotate in FIGS. 5A-5C; see also the example channels in FIG. 4).

The base may be a rigid frame that secures other components of the device. For example, the base includes a bottom frame portion (e.g., that includes a rail and/or mounts the device to an external object) and two side frame portions coupled to the bottom frame, where many components of the device are secured within those three frame portions. The sled may translate on the bottom frame portion and between the side frame portions. The shaft may extend between the two side frame portions and the two side frame portions secure ends of the shaft (e.g., substantially perpendicular to the sled axis) so that the lever can rotate about the shaft as the sled moves along the sled axis (for example, ends of the shaft fit into holes of the two side frame portions). See e.g., FIGS. 3 and 5-6.

The sled may be a structure that holds the guide plate in place and moves along the sled axis. For example, the sled 305 includes a flat plate that supports the guide plate (e.g., with holes configured to receive screws or bolts that couple the guide plate to the sled). The plane of the guide plate may be substantially perpendicular to the plane of the sled plate. See e.g., FIG. 6.

The lever may be a rigid bar that is mounted to the shaft. For example, the shaft is within a hole of the lever that is between the first and second ends, such that when a force is applied to one of the ends (e.g., via the first guide pin moving along the first channel), the lever rotates about the shaft. See e.g., FIGS. 3 and 5-6.

In some aspects, due to the first guide pin of the first end of the lever being configured to move through a path of the channel as the sled translates along the sled axis, the amount of rotation of the second end is a function of the path of the first channel and length of the first lever.

In some aspects, due to the first guide pin of the first end of the lever being configured to move through a path of the channel as the sled translates along the sled axis, the direction of rotation of the second end about the shaft is a function of the path of the first channel path and the movement direction of the sled. For example, referring to FIG. 4, if a pin (e.g., 409) moves down a slopped portion of a channel (e.g., 403), the corresponding lever may rotate in a first direction. However, if the pin moves up a slopped portion of a channel (e.g., pin 409 moves from right to left), the corresponding lever may rotate in a direction opposite the first direction.

In some aspects, the second end rotates about the shaft toward the direction the sled translates (e.g., due to the channel path or the lever is a reverse lever, such as reverse lever 615c).

In some aspects, the second end rotates about the shaft away from the direction the sled translates (e.g., see FIGS. 5A-5C).

In some aspects, the first lever (e.g., 615c) further includes: a first segment (e.g., 651) coupled to the shaft and extending in a first direction (e.g., away from the sled); a second segment (e.g., 652) coupled to the first segment and extending in second direction substantially perpendicular to the first direction; and a third segment (e.g., 653) coupled to the second segment and extending in a third direction substantially perpendicular to the second direction. In some aspects, at least one of: the third direction is substantially parallel to the first direction (e.g., see FIG. 6); or the second segment is curved such that the first, second, and third portions of the first lever form a U-shape.

In some aspects, the device further includes: a second guide plate (e.g., 609b) coupled to the sled, the second guide plate including a second channel (e.g., see FIGS. 3 and 5-6). In some aspects, the first channel and the second channel have different paths (e.g., see the different channel paths in FIG. 4; the lever rotations in FIGS. 5A-5C also indicate this.).

In some aspects, the device further includes: a second lever coupled to the shaft and including a second guide pin that is positioned within the second channel such that as the sled translates along the sled axis: the first guide pin moves along the first channel to cause the first lever to rotate about the shaft, and the second guide pin moves along the second channel to cause the second lever to rotated about the shaft (e.g., see FIGS. 3-6 and their descriptions).

In some aspects, as the sled translates from a first end on the sled axis to a second end on the sled axis: due to the first channel and the second channel, the first lever rotates from a first position to a second position while the second lever remains stationary (e.g., see FIG. 4 and its description).

In some aspects, as the sled translates from the first end on the sled axis to the second end on the sled axis: due to the first channel and the second channel, after the first lever is in the second position, the second lever rotates from a third position to a fourth position while the first lever remains stationary (e.g., see FIG. 4 and its description).

In some aspects, as the sled translates along the sled axis, the first guide pin and the second guide pin simultaneously move along their respective channels (e.g., see FIG. 4 and its description).

In some aspects, the base is mounted such that gravity applies a force to the sled along the sled axis (e.g., see FIG. 6I). For example, the base is mounted to an external object or system such that the sled axis is vertical and/or substantially parallel to the direction of gravity.

In some aspects, the device further includes a mechanism configured to, after the sled has moved past a threshold point while translating in a first direction, prevent the sled from mast past the threshold point while translating in a second direction opposite the first direction. For example, the base includes a (e.g., a spring-loaded) knob (or switch or gear) that allows movement of the sled over the knob when the sled moves along one direction. However, the knob engages with the sled if the sled modes along the opposite direction, thus preventing the sled from moving over the knob in the opposite direction (e.g., if an emergency situation occurs). The knob may be controlled (e.g., electromechanically controlled) to retract under normal operating conditions though.

In some aspects, the second end includes an output coupling location (e.g., 333, 533, 633) that is coupled to an engine input. In some aspects, causing the second end of the first lever to rotate about the shaft controls the engine input. In some aspects, the engine input is an input to an engine of a rotorcraft.

In some aspects, the sled is configured to translate along the sled axis in accordance with displacement of an electromechanical actuator (e.g., 683) that is coupled to the sled.

In some aspects, the sled translates along the sled axis on a rail (e.g., 323, 523, 623) of the base. For example, the sled includes wheels or cogs that roll along the rail. In another example, sled includes a clip (e.g., clip 690) that interlocks with the rail.

Some aspects relate to a device including: a drum (e.g., 709) coupled to a base (e.g., 703), the drum configured to rotate about a drum rotation axis (e.g., 712), the drum including a first channel (e.g., 739) along an outer surface of the drum; and a first lever (e.g., 715) coupled to a shaft (e.g., 707) that is fixed to the base, the first lever having a first end and a second end (e.g., including an output coupling location e.g., 733), the first end including a first guide pin that is positioned within the first channel such that as the drum rotates about the drum rotation axis, the first guide pin moves along the first channel to cause the first lever to translate along the shaft (e.g., along the lever axis 725).

The base may be a rigid frame that secures other components of the device. For example, the base includes a bottom frame portion (e.g., that mounts the device to an external object) and two side frame portions coupled to the bottom frame, where many components of the device are secured within those three frame portions (e.g., see FIG. 7). An axel (e.g., 790) may pass through the drum and enable the drum to rotate (about the drum rotation axis). The axel may extend between the two side frame portions and the two side frame portions may secure ends of the axel (e.g., ends of the axel fit into holes of the side frame portions), for example, such that the drum is raised about the bottom frame portion of the base.

In some aspects, the shaft includes an anti-rotation structure (e.g., 750) that prevents the shaft from rotating about the central axis of the shaft (parallel with the lever axis 725).

In some aspects, the shaft includes an anti-rotation feature (e.g., 750) that engages with the first lever, the anti-rotation feature preventing the first lever from rotating about the central axis of the shaft (parallel with the lever axis 725).

In some aspects, the amount of translation and the direction of translation of the first lever along the shaft is a function of a path of the first channel on the drum.

In some aspects, the first lever translates along the shaft in a direction substantially parallel to the drum rotation axis (e.g., see FIG. 7 and its description).

In some aspects, the drum includes a second channel that does not intersect the first channel (e.g., see FIGS. 7-8 and their descriptions).

In some aspects, the device further includes: a second lever coupled to the shaft, the second lever having a first end and a second end, the first end including a second guide pin that is positioned within the second channel such that as the drum rotates about the drum rotation axis: the first guide pin moves along the first channel to cause the first lever to translate along the shaft; and the second guide pin moves along the second channel to cause the second lever to translate along the shaft (e.g., see FIGS. 7-8 and their descriptions).

In some aspects, the second end of the first lever extends along a first direction, and the second end of the second lever extends along a second direction different than the first direction (e.g., see FIG. 7 and its description).

In some aspects, the first channel and the second channel have different paths on the drum (e.g., see FIG. 8 and its description).

In some aspects, as the drum rotates about the drum rotation axis: due to the first channel and the second channel, the first lever translates along the shaft from a first position to a second position on the shaft while the second lever remains substantially stationary on the shaft (e.g., see FIG. 8 and its description). Substantially stationary in this context refers to the lever not translating more than one centimeter along the shaft (e.g., along lever axis 725).

In some aspects, as the drum rotates about the drum rotation axis: due to the first channel and the second channel, after the first lever is in the second position, the second lever translates along the shaft from a third position to a fourth position on the shaft while the first lever remains substantially stationary on the shaft (e.g., see FIG. 8 and its description). Substantially stationary in this context refers to the lever not translating more than one centimeter along the shaft (e.g., along lever axis 725).

In some aspects, as the drum rotates about the drum rotation axis, the first guide pin and the second guide pin simultaneously move along their respective channels (e.g., see FIG. 8 and its description).

In some aspects, the drum includes a third channel that does not intersect the first channel or the second channels (e.g., see FIGS. 7-8 and their descriptions).

In some aspects, the device further includes: a third lever coupled to the shaft, the third lever having a first end and a second end, the first end including a third guide pin that is positioned within the third channel such that as the drum rotates about the drum rotation axis: the first guide pin moves along the first channel to cause the first lever to translate along the shaft; the second guide pin moves along the second channel to cause the second lever to translate along the shaft; and the third guide pin moves along the third channel to cause the third lever to translate along the shaft (e.g., see FIGS. 7-8 and their descriptions).

In some aspects, the first channel, the second, channel, and the third channel have different paths on the drum (e.g., see FIGS. 7-8 and their descriptions).

In some aspects, as the drum rotates about the drum rotation axis: the first lever translates along the shaft from a first position to a second position on the shaft while the second lever and the third lever remain substantially stationary on the shaft; after the first lever is in the second position, the second lever translates along the shaft from a third position to a fourth position on the shaft while the first lever and the third lever remain substantially stationary on the shaft; and after the second lever is in the second position, the second lever translates along the shaft from a fifth position to a sixth position on the shaft while the first lever and the second lever remain substantially stationary on the shaft (e.g., see FIG. 8 and its description). Substantially stationary in this context refers to the lever not translating more than one centimeter along the shaft (e.g., along lever axis 725).

In some aspects, the drum is configured to rotate about the drum rotation axis in accordance with an electromechanical actuator that is coupled to the drum (e.g., via receiver assembly 711).

In some aspects, the second end includes an output coupling location that is coupled to an engine input. In some aspects, causing the first lever to translate along the shaft controls the engine input. In some aspects, the engine input is an input to an engine of a rotorcraft.

Other aspects include components, devices, systems, improvements, methods, processes, applications, computer readable mediums, and other technologies related to any of the above.

### Computing Machine Architecture

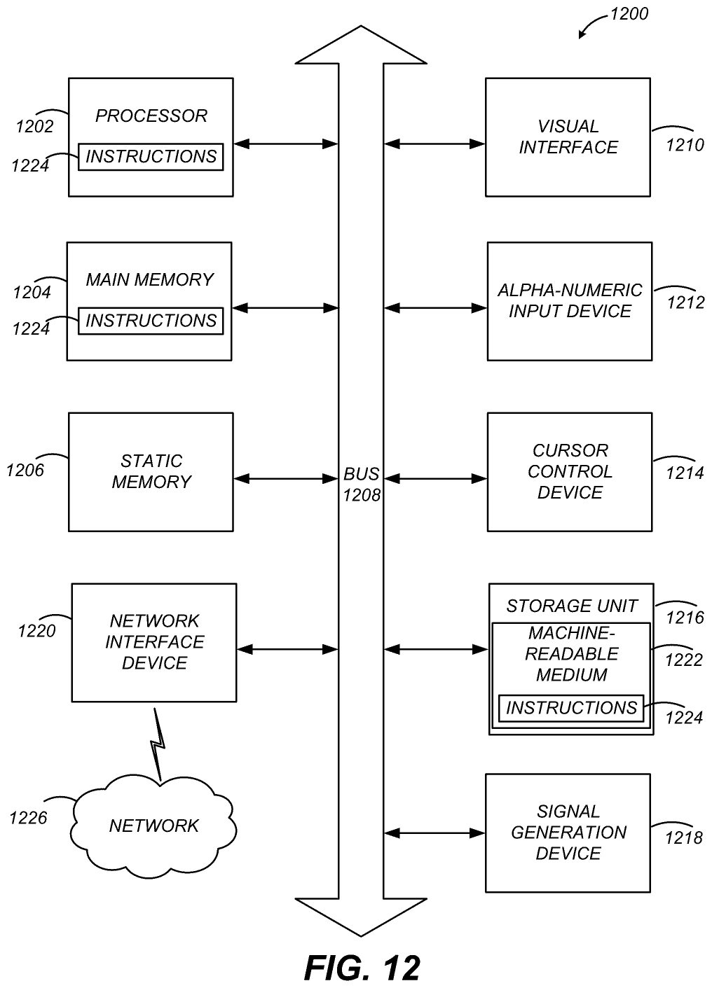

FIG. 12 is a block diagram illustrating one example embodiment of components of an example machine able to read instructions from a machine-readable medium and execute them in one or more processors (or controllers). Specifically, FIG. 12 shows a diagrammatic representation of a machine in the example form of a computer system 1200 within which program code (e.g., software) for causing the machine to perform any one or more of the methodologies discussed herein may be executed. The computer system 1200 may be used for one or more components of the vehicle control and interface system 100, the actuator (e.g., 130, 683), or some combination thereof. The program code may be comprised of instructions 1224 executable by one or more processors 1202 (e.g., working individually or collectively). In alternative embodiments, the machine operates as a standalone device or may be coupled (e.g., networked) to other machines. In a networked deployment, the machine may operate in the capacity of a server machine or a client machine in a server-client network environment, or as a peer machine in a peer-to-peer (or distributed) network environment. By way of example, the signals generated by operation of an EMM may be translated to instructions executable by the computer system, including to configure and generate the user interfaces of FIGS. 9-11 on a screen.

The machine may be a computing system capable of executing instructions 1224 (sequential or otherwise) that specify actions to be taken by that machine. Further, while only a single machine is illustrated, the term “machine” shall also be taken to include any collection of machines that individually or jointly execute instructions 124 to perform any one or more of the methodologies discussed herein.

The example computer system 1200 includes one or more processors 1202 (e.g., one or more central processing units (CPUs), one or more graphics processing unit (GPUs), one or more digital signal processors (DSPs), one or more application specific integrated circuits (ASICs), one or more radio-frequency integrated circuits (RFICs), one or more field programmable gate arrays (FPGAs), or some combination thereof), a main memory 1204, and a static memory 1206, which are configured to communicate with each other via a bus 1208. The computer system 1200 may further include visual display interface 1210 (example display interfaces 1210 include 210 and 230). The visual interface may include a software driver that enables (or provide) user interfaces to render on a screen either directly or indirectly. The visual interface 1210 may interface with a touch enabled screen. The computer system 1200 may also include input devices 1212 (e.g., a keyboard a mouse), a storage unit 1216, a signal generation device 1218 (e.g., a microphone and/or speaker), and a network interface device 1220, which also are configured to communicate via the bus 1208.

The storage unit 1216 includes a machine-readable medium 1222 (e.g., magnetic disk or solid-state memory) on which is stored instructions 1224 (e.g., software) embodying any one or more of the methodologies or functions described herein. The instructions 1224 (e.g., software) may also reside, completely or at least partially, within the main memory 1204 or within the processor 1202 (e.g., within a processor's cache memory) during execution.

### Additional Configuration Information

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component.

Similarly, structures and functionality presented as a single component may be implemented as separate components. These and other variations, modifications, additions, and improvements fall within the scope of the subject matter herein.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

In addition, use of the “a” or “an” are employed to describe elements and components of the embodiments. This is done merely for convenience and to give a general sense of the disclosure. This description should be read to include one or at least one and the singular also includes the plural unless it is obvious that it is meant otherwise.

Certain embodiments are described herein as including logic or a number of components, modules, or mechanisms. Modules may constitute either software modules (e.g., code embodied on a machine-readable medium and processor executable) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module is a tangible component that may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs for engine management modules (EMMs) through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A device comprising:
a drum coupled to a base, the drum configured to rotate about a drum rotation axis, the drum including a first channel along an outer surface of the drum; and
a first lever coupled to a shaft that is fixed to the base, the first lever having a first end and a second end, the first end including a first guide pin that is positioned within the first channel such that as the drum rotates about the drum rotation axis, the first guide pin moves along the first channel to cause the first lever to translate along the shaft.

2. The device of claim 1, wherein the shaft includes an anti-rotation structure that prevents the shaft from rotating about an axis of the shaft.

3. The device of claim 1, wherein the shaft includes an anti-rotation feature that engages with the first lever, the anti-rotation feature preventing the first lever from rotating about an axis of the shaft.

4. The device of claim 1, wherein the amount of translation and the direction of translation of the first lever along the shaft is a function of a path of the first channel on the drum.

5. The device of claim 1, wherein the first lever translates along the shaft in a direction substantially parallel to the drum rotation axis.

6. The device of claim 1, wherein the drum includes a second channel that does not intersect the first channel.

7. The device of claim 6, further comprising:
a second lever coupled to the shaft, the second lever having a first end and a second end, the first end including a second guide pin that is positioned within the second channel such that as the drum rotates about the drum rotation axis:
the first guide pin moves along the first channel to cause the first lever to translate along the shaft; and
the second guide pin moves along the second channel to cause the second lever to translate along the shaft.

8. The device of claim 7, wherein the second end of the first lever extends along a first direction, and the second end of the second lever extends along a second direction different than the first direction.

9. The device of claim 7, wherein the first channel and the second channel have different paths on the drum.

10. The device of claim 7, wherein as the drum rotates about the drum rotation axis:
due to the first channel and the second channel, the first lever translates along the shaft from a first position to a second position on the shaft while the second lever remains substantially stationary on the shaft.

11. The device of claim 7, wherein, as the drum rotates about the drum rotation axis:
due to the first channel and the second channel, after the first lever is in the second position, the second lever translates along the shaft from a third position to a fourth position on the shaft while the first lever remains substantially stationary on the shaft.

12. The device of claim 7, wherein as the drum rotates about the drum rotation axis, the first guide pin and the second guide pin simultaneously move along their respective channels.

13. The device of claim 7, wherein the drum includes a third channel that does not intersect the first channel or the second channels.

14. The device of claim 13, further comprising:
a third lever coupled to the shaft, the third lever having a first end and a second end, the first end including a third guide pin that is positioned within the third channel such that as the drum rotates about the drum rotation axis:
the first guide pin moves along the first channel to cause the first lever to translate along the shaft;
the second guide pin moves along the second channel to cause the second lever to translate along the shaft; and
the third guide pin moves along the third channel to cause the third lever to translate along the shaft.

15. The device of claim 14, wherein the first channel, the second, channel, and the third channel have different paths on the drum.

16. The device of claim 14, wherein as the drum rotates about the drum rotation axis:
the first lever translates along the shaft from a first position to a second position on the shaft while the second lever and the third lever remain substantially stationary on the shaft;
after the first lever is in the second position, the second lever translates along the shaft from a third position to a fourth position on the shaft while the first lever and the third lever remain substantially stationary on the shaft; and
after the second lever is in the second position, the second lever translates along the shaft from a fifth position to a sixth position on the shaft while the first lever and the second lever remain substantially stationary on the shaft.

17. The device of claim 1, wherein the drum is configured to rotate about the drum rotation axis in accordance with an electromechanical actuator that is coupled to the drum.

18. The device of claim 1, wherein the second end includes an output coupling location that is coupled to an engine input.

19. The device of claim 18, wherein causing the first lever to translate along the shaft controls the engine input.

20. The device of claim 18, wherein the engine input is an input to an engine of a rotorcraft.
